(19) United States
(12) Patent Application Publication
(10) Pub. No.: US 2006/0238473 A1
(43) Pub. Date: Oct. 26, 2006

(54) Display driver circuit and display apparatus

(75) Inventor: Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/409,993

(22) Filed: Apr. 25, 2006

(30) Foreign Application Priority Data
Apr. 26, 2005 (JP) 2005-128628
Jun. 21, 2005 (JP) 2005-180230

(51) Int. Cl. G09G 3/36

(52) U.S. Cl. 345/89

(57) ABSTRACT

A driver circuit includes an analog voltage signal generating circuit configured to generate first and second groups of analog voltage signals; a first D/A converter configured to operate in a first voltage range between a first voltage and a second voltage which is lower than the first voltage, and to output a first one of the first group of analog voltage signals based on a lower bit group of an input digital signal; and a second D/A converter configured to operate in a second voltage range between the second voltage and a third voltage which is lower than the second voltage, and to output a second one of the second group of analog voltage signals based on the lower bit group out. A selecting circuit selects one of the first analog voltage signal and the second analog voltage signal as an analog voltage selection signal based on an upper bit group of the digital signal.

### BACKGROUND OF THE INVENTION

1. Field of the Invention

The present invention relates to a digital-to-analog (D/A) converting circuit for converting a digital signal into an analog signal, a display driver circuit using the same, and a display apparatus using the display driver circuit.

2. Description of the Related Art

A D/A converting circuit is known in which various methods such as a resistor string method and a switched capacitor method are adopted to convert a digital signal to an analog signal. In the resistor string method, for example, a plurality of gradation voltages are generated from a plurality of reference voltages through voltage division and provided to a plurality of switches, so that a desired gradation voltage is selected from among the plurality of gradation voltages in accordance with the digital signal. The switched capacitor method employs switches and capacitors.

Such D/A converting circuits are also used for a liquid crystal display panel driver to drive a liquid crystal panel. In liquid crystal display, a gamma correction is carried out to realize a natural gradation display, and a relation between an input signal and an output signal in the D/A converting circuit is not linear but is nonlinear. Therefore, the D/A converting circuit of the resistor string method which is excellent in a monotonically increasing characteristic, is often used in the liquid crystal display apparatus.

For example, a conventional D/A converting circuit of the resistor string method is disclosed in Japanese Laid Open Patent Publication (JP-P2002-175060A) as a first conventional example. The first conventional example of the D/A converting circuit selects one from among 64 gradation voltages in accordance with a 6-bit digital signal D0 to D5. Specifically, 64 switches are controlled based on the least significant bit D0 of the digital signal to select 32 gradation voltages from among the above 64 gradation voltages. 32 switches are controlled based on the digital signal D1 to select 16 gradation voltages from the above 32 gradation voltages. 16 switches are controlled based on the digital signal bit D2 to select 8 gradation voltages from among the above 16 gradation voltages. 8 switches are controlled based on the digital signal bit D3 to select 4 gradation voltages from among the above 8 gradation voltages. 4 switches are controlled based on the digital signal bit D4 to select 2 gradation voltages from the above 4 gradation voltages. 2 switches are controlled based on the most significant bit D5 of the digital signal to select one gradation voltage from among the above 2 gradation voltages. Thus, a desired gradation voltage is selected in a tournament system to drive the liquid crystal display panel.

In a liquid crystal display apparatus, a driving voltage of liquid crystal is higher than an operation voltage of a logic section such as a latch circuit to hold a digital signal. Therefore, a breakdown voltage of a component to configure a D/A converting circuit for driving the liquid crystal is designed to be higher than a breakdown voltage of a component to configure the logic section. In order to increase the breakdown voltage in a MOS transistor, a longer gate length L and a thicker gate oxide film Tox are required. However, these will cause a reduction of a driving capability in a transistor. A gate width W needs to be enlarged to maintain the driving capability in the transistor. That is, a circuit area is exponentially expanded in accordance with the increase of the breakdown voltage of the components, which configure the D/A converting circuit.

In addition, in the liquid crystal display apparatus, a polarity of a voltage (hereinafter, “pixel voltage”) applied to each pixel through a thin film transistor (TFT) from a data line is inverted for every predetermined time period. Namely, the pixel is driven in an alternating-current manner. The “polarity” indicates herein whether the pixel voltage is positive or negative relative to a voltage of a common electrode (common voltage). This driving method is applied to suppress deterioration of liquid crystal material. A “dot inversion driving method” is also known to drive a data line and a scan line so that pixel voltages applied to adjacent pixels have polarities inverted from each other. If the dot inversion driving method is applied, flickers are reduced and an image quality is improved.

In a driver circuit that drives the liquid crystal display panel of this type, it is preferable that the driver circuit has an area as small as possible. A conventional technique for reducing the chip area of the driver circuit is disclosed in Japanese Laid Open Patent Publication (JP-A-Heisei 11-184444) as a second conventional example.

A data line driver circuit of the second conventional example includes a D/A converter that converts a digital signal into an analog signal, and an amplifier that amplifies a voltage level of the output signal of the D/A converter to a level for driving the liquid crystal display panel. An amplification factor α of the amplifier is higher than one. Specifically, the amplifier is configured so that a resistor R1 is provided between a reference voltage terminal and an inversion input terminal, and that a resistor Rf is provided between an output terminal and the inversion input terminal. In this case, the relationship between an input voltage Vin and an output voltage Vout is represented by the following equation.
Vout=Vin×(1+Rf/R1)

Since the amplifier is provided to have the amplification factor α higher than one, the voltage level of the signal sent from the D/A converter to the amplifier can be set to 1/α of the pixel voltage. Accordingly, a breakdown voltage of components such as transistors of the D/A converter can be reduced, so that a chip area of the D/A converter can be reduced.

However, the inventor of the present invention discovered that the technique disclosed in the second conventional example has the following disadvantages. That is, the D/A converter and the amplifier are provided for every data line. However, amplification factors α (>1) of the respective amplifiers have a distribution due to a manufacturing deviation in the resistors R1 and Rf. This causes deterioration in an accuracy of the pixel voltage supplied to each data line, and causes degradation in the image quality such as occurrence of a “blur” in the form of a vertical bar. Especially, if the dot inversion driving method is used, the “blur” occurs between adjacent data lines. Thus, this method is adversely influenced by the irregular amplification factors α more conspicuously.

### SUMMARY OF THE INVENTION

In an aspect of the present invention, a driver circuit includes an analog voltage signal generating circuit configured to generate first and second groups of analog voltage signals; a first D/A converter configured to operate in a first voltage range between a first voltage and a second voltage which is lower than the first voltage, and to output a first one of the first group of analog voltage signals based on a lower bit group of an input digital signal; a second D/A converter configured to operate in a second voltage range between the second voltage and a third voltage which is lower than the second voltage, and to output a second one of the second group of analog voltage signals based on the lower bit group out; and a selecting circuit configured to select one of the first analog voltage signal and the second analog voltage signal as an analog voltage selection signal based on an upper bit group of the digital signal.

Here, the second voltage may be a system ground voltage.

Also, the selecting circuit may operate in a third voltage range between a voltage higher than the first voltage and a voltage lower than the third voltage.

Also, the driver circuit may further include a buffer provided between the selecting circuit and an output terminal and configured to operate in a third voltage range between the first voltage and the fourth voltage.

Also, the driver circuit may further include a precharging circuit configured to precharge a wiring line between the selecting circuit and an output terminal to a predetermined voltage. In this case, the wiring line may be precharged when a value of the upper bit group is changed. Also, when the value of the upper bit group is changed, the precharge may be carried out after the selecting circuit disconnects the precharging circuit from the first and second D/A converters. Also, the predetermined voltage may be the second voltage.

Also, when each of the first D/A converter, the second D/A converter, and the selecting circuit has a MOS transistor, it is preferable that gate insulating films of the MOS transistors in the first and second D/A converters are thinner than a gate insulating film of the MOS transistor in the selecting circuit.

Also, when each of the first D/A converter, the second D/A converter, and the selecting circuit has a MOS transistor, it is preferable that gate lengths of the MOS transistors in the first and second D/A converters are shorter than a gate length of the MOS transistor in the selecting circuit.

In another aspect of the present invention, a driver circuit includes an analog voltage signal generating circuit configured to generate first to fourth groups of analog voltage signals; a first D/A converter configured to operate in a first voltage range between a first voltage and a second voltage which is lower than the first voltage, and to output a first one of the first group of analog voltage signals based on a lower bit group of an input digital signal; a second D/A converter configured to operate in a second voltage range between the second voltage and a third voltage which is lower than the second voltage, and to output a second one of the second group of analog voltage signals based on the lower bit group out; a third D/A converter configured to operate in a third voltage range between a third voltage and a fourth voltage which is lower than the third voltage, and to output a third one of the first group of analog voltage signals based on a lower bit group of an input digital signal; a fourth D/A converter configured to operate in a fourth voltage range between the fourth voltage and a fifth voltage which is lower than the fourth voltage, and to output a fourth one of the fourth group of analog voltage signals based on the lower bit group out; a first selecting circuit configured to select one of the first analog voltage signal and the second analog voltage signal as a first analog voltage selection signal based on an upper bit group of the digital signal; and a second selecting circuit configured to select one of the third analog voltage signal and the fourth analog voltage signal as a second analog voltage selection signal based on the upper bit group of the digital signal.

Here, the third voltage may be a system ground voltage.

Also, the first selecting circuit may operate in a fifth voltage range between a sixth voltage higher than the first voltage and the third voltage, and the second selecting circuit may operate in a sixth voltage range between the third voltage and a seventh voltage lower than the fifth voltage.

Also, the driver circuit may further include a third selecting circuit configured to select one of the first analog voltage selection signal and the second analog voltage selection signal as an analog voltage selection signal based on the upper bit group of the digital signal; and a buffer provided between the third selecting circuit and an output terminal and configured to operate in a seven voltage range between the sixth voltage and the seventh voltage.

Also, the driver circuit may further include an output switching circuit configured to output one of the first analog voltage selection signal and the second analog voltage selection signal as an analog voltage selection signal to one of adjacent output terminals and the other of the selection signals to the other of the adjacent output terminals based on a polarity signal.

Also, the driver circuit may further include a precharging circuit provided between the first and second selecting circuits and the output switching circuit and configured to precharge first wiring lines between the first and second selecting circuits and the output switching circuit to first and second predetermined voltages, and second wiring lines between the first wiring lines and the output terminals to a third predetermined voltage.

In this case, the first wiring lines may be precharged when a value of the upper bit group is changed, and the second wiring lines may be precharged in response to a polarity signal. Also, when the value of the upper bit group is changed, the precharge may be carried out after the first and second selecting circuits disconnect the precharging circuit from the first to fourth D/A converters.

Also, the first predetermined voltage may be the second voltage, the second predetermined voltage may be the fourth voltage, and the third predetermined voltage may be a ground voltage.

Also, each of the first to fourth D/A converter, the first and second selecting circuit, the precharging circuit, and the output switching circuit has a MOS transistor. Gate insulating films of the MOS transistors in the first to fourth D/A converters may be thinner than gate insulating films of the MOS transistors in the first and second selecting circuits, and the gate insulating films of the MOS transistors in the first and second selecting circuits may be thinner than a gate insulating film of the MOS transistor in the output switching circuit.

Also, gate lengths of the MOS transistors in the first to fourth D/A converters may be shorter than gate lengths of the MOS transistors in the first and second selecting circuits, and the gate lengths of the MOS transistors in the first to fourth D/A converters may be shorter than a gate length of the MOS transistor in the output switching circuit.

In still another aspect of the present invention, a display apparatus includes a display panel having data lines; and a driver circuit configured to drive the display panel based on a digital signal by driving the data lines. The driver circuit includes a logic circuit configured to latch the digital signal having a lower bit group and a higher bit group; an analog voltage signal generating circuit configured to generate first and second groups of analog voltage signals; and a digital-to-analog (D/A) converting circuit configured to drive the data lines based on the digital signal by using the first and second groups of analog voltage signals. The D/A converting circuit includes a first D/A converter configured to operate in a first voltage range between a first voltage and a second voltage which is lower than the first voltage, and to output a first one of the first group of analog voltage signals based on the lower bit group of an input digital signal; a second D/A converter configured to operate in a second voltage range between the second voltage and a third voltage which is lower than the second voltage, and to output a second one of the second group of analog voltage signals based on the lower bit group out; and a first selecting circuit configured to operate in a third voltage range between a voltage higher than the first voltage and a voltage lower than the third voltage, and to select one of the first analog voltage signal and the second analog voltage signal as a first analog voltage selection signal based on the upper bit group of the digital signal.

Here, the /A converting circuit may further include a buffer configured to drive one of the data lines based on the first analog voltage selection signal.

Also, the analog voltage signal generating circuit further generates third and fourth groups of analog voltage signals in addition to the first and second groups of analog voltage signals. The D/A converting circuit may further include a third D/A converter configured to operate in a third voltage range between a third voltage and a fourth voltage which is lower than the third voltage, and to output a third one of the first group of analog voltage signals based on a lower bit group of an input digital signal; a fourth D/A converter configured to operate in a fourth voltage range between the fourth voltage and a fifth voltage which is lower than the fourth voltage, and to output a fourth one of the fourth group of analog voltage signals based on the lower bit group out; a second selecting circuit configured to select one of the third analog voltage signal and the fourth analog voltage signal as a second analog voltage selection signal based on the upper bit group of the digital signal; and an output switching circuit configured to output one of the first analog voltage selection signal and the second analog voltage selection signal as an analog voltage selection signal to one of adjacent output terminals and the other of the selection signals to the other of the adjacent output terminals based on a polarity signal.

Also, the display apparatus may further include a level shift circuit group provided between the logic circuit and the D/A converting circuit, and comprising first to third level shift circuits. The first level shift circuit may receive the lower bit group from the logic circuit, and output the lower bit group to the first D/A converter after converting the lower bit group to fit with the first voltage range. The second level shift circuit may receive the lower bit group from the logic circuit, and may output the lower bit group to the second D/A converter after changing the lower bit group to fit with the second voltage range. The third level shift circuit may receive the upper bit group from the logic circuit, and may output the upper bit group to the first selecting circuit after changing the upper bit group to fit with the third voltage range.

Also, the display apparatus may further include a level shift circuit group provided between the logic circuit and the D/A converting circuit, and composed of first to seventh level shift circuits. The first level shift circuit may receive the lower bit group from the logic circuit, and may output the lower bit group to the first D/A converter after converting the lower bit group to fit with the first voltage range. The second level shift circuit may receive the lower bit group from the logic circuit, and may output the lower bit group to the second D/A converter after changing the lower bit group to fit with the second voltage range. The third level shift circuit may receive the lower bit group from the logic circuit, and may output the lower bit group to the third D/A converter after converting the lower bit group to fit with the third voltage range. The fourth level shift circuit may receive the lower bit group from the logic circuit, and may output the lower bit group to the fourth D/A converter after changing the lower bit group to fit with the fourth voltage range. The fifth level shift circuit may receive the upper bit group from the logic circuit, and may output the upper bit group to the first selecting circuit after changing the upper bit group to fit with the fifth voltage range. The sixth level shift circuit may receive the upper bit group from the logic circuit, and may output the upper bit group to the second selecting circuit after changing the upper bit group to fit with the sixth voltage range. The seventh level shift circuit may receive a polarity signal from the logic circuit, and may output the polarity signal to the output switching circuit after changing the polarity signal to fit with the seventh voltage range.

### BRIEF DESCRIPTION OF THE DRAWINGS

FIG. 1 is a conceptual diagram showing a digital signal used in the present invention;

FIG. 2 is a conceptual diagram showing voltage levels of an analog voltage signal in the present invention;

FIG. 3 is a block diagram showing a configuration of a D/A converting circuit according to the present invention;

FIG. 4A is a circuit diagram showing an example of the configuration of the D/A converting circuit according to the present invention;

FIG. 4B is a circuit diagram showing another example of the configuration of the D/A converting circuit according to the present invention;

FIG. 5 is a top view showing a schematic layout of the D/A converting circuit according to the present invention;

FIG. 6 is a cross-sectional view showing a typical configuration of the D/A converting circuit along the B-B′ line shown in FIG. 5;

FIG. 7 is a block diagram showing a configuration of a liquid crystal display apparatus according to the present invention;

FIG. 8 is a block diagram showing a configuration of a driver circuit according to a first embodiment of the present invention;

FIGS. 9A and 9B are block diagrams showing different configurations of a gradation voltage generating circuit in the driver circuit according to the first embodiment of the present invention;

FIG. 10 is a diagram showing a relation between a gradation voltage and a gradation in the driver circuit according to the first embodiment of the present invention;

FIG. 11 is a circuit diagram showing the configuration of a level shift circuit in the display driver circuit according to the first embodiment of the present invention;

FIG. 12 is a circuit diagram showing the configuration of the level shift circuit in the driver circuit according to the first embodiment of the present invention;

FIGS. 13A to 13C are timing charts showing an operation of the driver circuit according to the first embodiments of the present invention;

FIG. 14 is a block diagram showing the configuration of the driver circuit according to a second embodiment of the present invention;

FIG. 15 is a block diagram showing the configuration of the driver circuit according to a third embodiment of the present invention;

FIG. 16 is a block diagram showing the configuration of the D/A converting circuit in the driver circuit according to a fourth embodiment of the present invention;

FIG. 17 is a diagram showing a relation between a gradation voltage and a gradation in the present invention;

FIG. 18 is a block diagram showing the configuration of another example of the liquid crystal display apparatus according to the present invention;

FIG. 19 is a block diagram showing the configuration of the driver circuit according to the present invention;

FIG. 20 is a graph showing a correspondence between a gradation and a gradation voltage in the present invention;

FIG. 21 is a block diagram showing the configuration of the D/A converting circuit in the driver circuit according to a fifth embodiment of the present invention;

FIG. 22A is a circuit block diagram of one example of a configuration of a gradation voltage generating circuit;

FIG. 22B is a circuit block diagram of another example of the configuration of the gradation voltage generating circuit;

FIG. 23 is a block diagram of the configuration of the level shift circuit group in the driver circuit according to a sixth embodiment of the present invention;

FIG. 24 is a circuit block diagram of a configuration necessary for a precharge operation in the driver circuit according to a seventh embodiment of the present invention;

FIGS. 25A to 25T are timing charts showing an operation of the driver circuit according to the seventh embodiment of the present invention;

FIG. 26 is a top view showing a layout of the driver circuit according to the seventh embodiment of the present invention;

FIG. 27A is a cross-sectional view typically showing a structure taken along a line A-A′ of FIG. 26;

FIG. 27B is a cross-sectional view typically showing a structure taken along a line B-B′ of FIG. 26; and

FIG. 28 is a block diagram showing the configuration of the D/A converting circuit in the driver circuit according to an eighth embodiment of the present invention.

### DESCRIPTION OF THE PREFERRED EMBODIMENTS

Hereinafter, a display apparatus using a driver circuit with an analog-to-digital (A/D) converting circuit according to the present invention will be described with reference to the attached drawings. However, the present invention is not limited to the following embodiments. For example, a 6-bit digital signal is used in the following embodiments but the number of bits of the digital signal may be 5 or more and 7 or less in the present invention. Further, a person having ordinary skill in the art could easily change, additionally provide, or convert components according to the embodiments within the scope of the present invention.

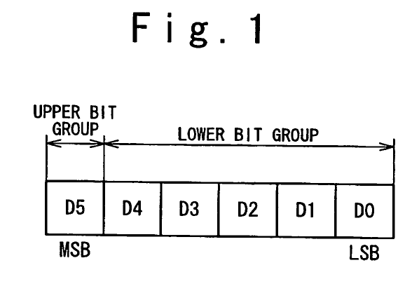

First of all, definition of words used in the present specification will be given below. The D/A converting circuit converts a digital signal to an analog voltage signal in accordance with the digital signal. The digital signal is of 6 bits D5, D4, D3, D2, D1 and D0, as shown in FIG. 1. The most significant bit (MSB) of the digital signal is D5, and the least significant bit (LSB) thereof is D0. In the present specification, a higher bit group means a bit group of at least one higher bit including the MSB. A lower bit group means a bit group of at least one lower bit including the LSB. In the example shown in FIG. 1, the higher bit group includes only the MSB D5 and the lower bit group includes the bits D4 to D0 excluding the MSB.

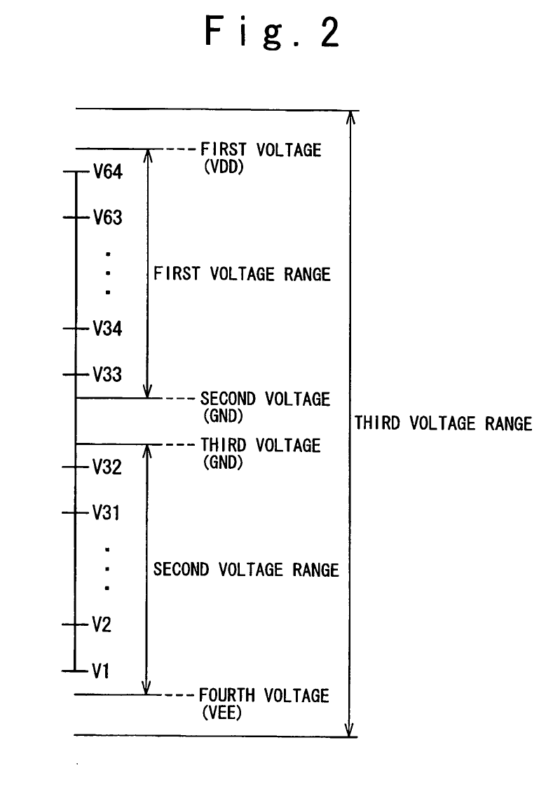

The 6-bit digital signal can express 64 kinds of data. The 64 kinds of the data are respectively related to 64 kinds of analog voltage signals. Voltages of the 64 kinds of the analog voltage signals are expressed as V1 to V64 in order on the basis of its own value, and a voltage of V1 is regarded as the lowest while a voltage of V64 is regarded as the highest as shown in FIG. 2. Among the 64 kinds of the voltages, a group of V33 to V64 having relatively high voltages is at least included in a first voltage range, and a group of V1 to V32 having relatively low voltages is at least included in a second voltage range. As shown in FIG. 2, the first voltage range is defined as a range between a first voltage VDD (e.g., 3V) and a second voltage (e.g., 0V) which is lower than the first voltage VDD. The second voltage range is also defined as a range between a third voltage (e.g., 0V) and a forth voltage VEE (e.g. −3V) which is lower than the second and third voltages. Thus, the first voltage range covers a range higher than the second voltage range. A voltage range including all the voltages from V1 to V64 is further referred to as a third voltage range. The third voltage range is defined as a range between a voltage (e.g., 5V) which is the first voltage VDD or more, and a voltage (e.g., −5V) which is the forth voltage VEE or less.

Among the 64 kinds of the analog voltage signals, a group of voltages V33 to V64 included in the first voltage range is referred to as a first voltage signal group. A group of voltages V1 to V32 included in the second voltage range is also referred to as a second voltage signal group. Each of the voltages V1 to V64 is occasionally used to indicate a voltage value as well as an analog voltage signal. For example, the first voltage signal group corresponding to the first voltage range is occasionally referred to as a first voltage signal group V33 to V64, and the second voltage signal group corresponding to the second voltage range is occasionally referred to as a second voltage signal group V1 to V32.

The 6-bit digital signal D0 to D5 mentioned above is related to the 64 kinds of the analog voltage signals V1 to V64. For example, a digital signal “000000” corresponds to the analog voltage signal V1, and a digital signal “011111” corresponds to the analog voltage signal V32. More specifically, a digital signal with the MSB D5 of “0” corresponds to the second voltage signal group V1 to V32. A digital signal of “100000” corresponds to the analog voltage signal V33, and a digital signal of “111111” corresponds to the analog voltage signal V64. Therefore, a digital signal with the MSB D5 of “1” corresponds to the first voltage signal group V33 to V64. In other words, the MSB D5 (the higher bit group) is used for selection of the first voltage signal group V33 to V64 or the second voltage signal group V1 to V32. Meanwhile, the lower bit group (D0 to D4) is used for specification of one signal among the first voltage signal group V33 to V64 or the second voltage signal group V1 to V32.

The D/A converting circuit in the driver circuit according to the present invention receives the above digital signal D0 to D5 and outputs one analog voltage signal selected from among a plurality of analog voltage signals V1 to V64 in accordance with the digital signal D0 to D5. Details of configurations, operations and effects of the D/A converting circuit will be described below.

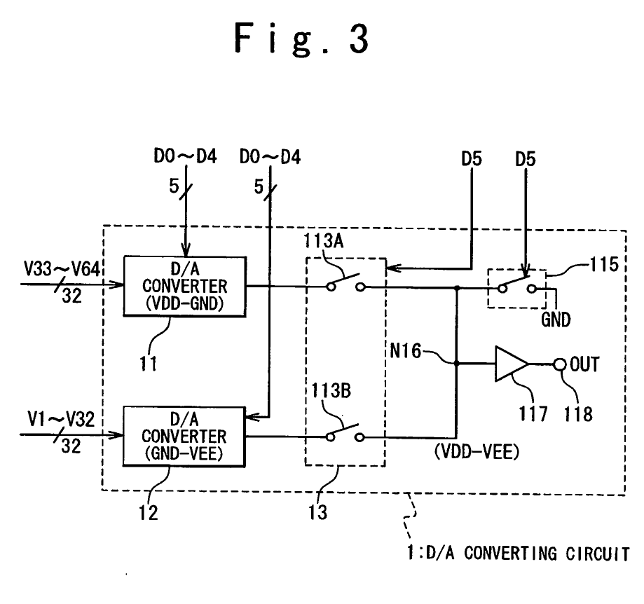

FIG. 3 is a block diagram showing a configuration of the D/A converting circuit 1 in the driver circuit according to the present invention. As shown in FIG. 3, the D/A converting circuit 1 receives the digital signal (the higher bit group D5 and the lower bit group D0 to D4) and the plurality of analog voltage signals V1 to V64. The D/A converting circuit 1 also includes a first D/A converter 11, a second D/A converter 12, a precharging circuit 115, a buffer 117, an output terminal 118 and a selecting circuit 13.

The first D/A converter 11 receives the lower bit group D0 to D4 of the digital signal and the first voltage signals V33 to V64. The first D/A converter 11 selects an analog voltage signal corresponding to the lower bit group D0 to D4 from among the first voltage signal group V33 to V64. The analog voltage signal selected from the first voltage signal group V33 to V64 is referred to as a first analog voltage signal. The first D/A converter 11 outputs the first analog voltage signal to the selecting circuit 13. The second D/A converter 12 receives the lower bit group D0 to D4 of the digital signal and the second voltage signals V1 to V32. The second D/A converter 12 selects an analog voltage signal corresponding to the lower bit group D0 to D4 from among the second voltage signal group V1 to V32. The analog voltage signal selected from the second voltage signal group V1 to V32 is referred to as a second analog voltage signal. The second D/A converter 12 outputs the second analog voltage signal to the selecting circuit 13.

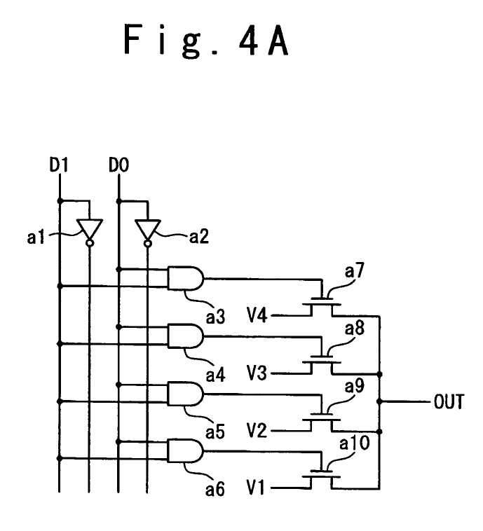

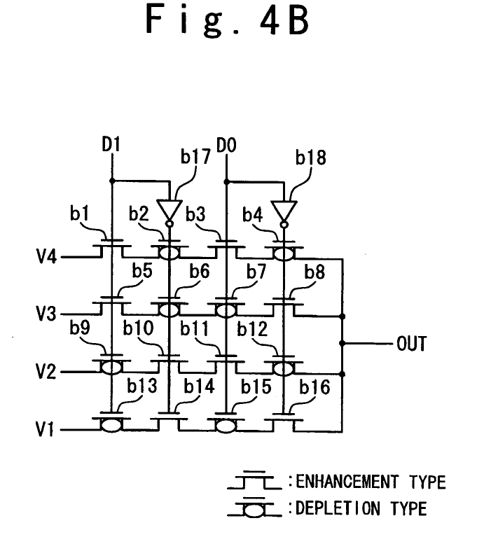

Examples of circuit configurations of the first D/A converter 11 and the second D/A converter 12 are shown in FIGS. 4A and 4B, respectively. For simplicity, a case of 2-bit digital signal D0 and D1 will be described. The D/A converter shown in FIG. 4A includes inverters a1 and a2, AND circuits a3 to a6, and transistors (switches) a7 to a10. Digital signal is decoded in a logic circuit of the inverters a1 and a2 and the AND circuits a3 to a6. Thus, one of the four switches a7 to a10 is turned on to select and output one voltage corresponding to the digital signal from among four kinds of voltages V1 to V4. The D/A converter shown in FIG. 4B includes a plurality of transistors b1 to b16 and inverters b17 and b18. However, the transistors b1, b3, b5, b8, b10, b11, b14 and b16 are enhancement-type transistors, and the other transistors are depletion-type transistors. A gate of each transistor is provided with one of bits D0 and D1 of the digital signal and inverted bits thereof. Thus, one voltage is selected and outputted from the four kinds of the voltages V1 to V4 in accordance with the digital signal. When the number of bits of the digital signal is different, the D/A converter can be realized in the same manner. Although it is not shown in any drawing, the first D/A converter 11 and the second D/A converter 12 may be D/A converters of the R-2R-system or switched capacitor system. Since a buffer is installed inside the D/A converter in these systems, a buffer 117 may be omitted.

According to the present invention, the first D/A converter 11 is configured to operate at least in the first voltage range (between the first voltage and the second voltage, see FIG. 2). The positive voltage VDD is shown as an example of the first voltage, and a system ground GND is shown as an example of the second voltage. In this case, the first D/A converter 11 is configured to operate in a positive voltage range between VDD and GND. The first D/A converter 11 receives the first voltage signal group V33 to V64 corresponding to the positive voltage range between VDD and GND, and selects a first analog voltage signal from among the first voltage signal group V33 to V64. The lower bit group D0 to D4 supplied to the first D/A converter 11 should be adjusted by a level shift circuit to fit with the first voltage range between VDD and GND.

Moreover, the second D/A converter 12 is configured to operate at least in the second voltage range (between the third voltage and the fourth voltage in FIG. 2). The system ground GND is shown as an example of the third voltage, and a negative voltage VEE is shown as an example of the fourth voltage. In this case, the second D/A converter 12 is configured to operate in a negative voltage range between GND and VEE. The second D/A converter 12 receives the second voltage signal group V1 to V32 corresponding to the negative voltage range between GND and VEE, and selects a second analog voltage signal from among the second voltage signal group V1 to V32. The lower bit group D0 to D4 supplied to the second D/A converter 12 should be adjusted by the level shift circuit to fit with the second voltage range between GND and VEE.

In the above example, the second voltage and the third voltage may be identical, and they are the system ground GND. The second voltage and the third voltage, however, may be different if the following equations are satisfied:

First voltage>Second voltage>Fourth voltage; and

First voltage>Third voltage>Fourth voltage.

The selecting circuit 13 will be described next. The selecting circuit 13 in the present invention is interposed between the first and second D/A converters 11 and 12, and the output terminal 118. The selecting circuit 13 receives the first analog voltage signal from the first D/A converter 11, and receives the second analog voltage signal from the second D/A converter 12. The selecting circuit 13 also receives the higher bit group of the digital signal (the MSB D5). As described above, the MSB D5 indicates either the first voltage signal group V33 to V64 or the second voltage signal group V1 to V32 by its own value. The first analog voltage signal is an analog voltage signal selected from among the first voltage signal group V33 to V64, and the second analog voltage signal is an analog voltage signal selected from among the second voltage signal group V1 to V32. Therefore, the selecting circuit 13 can select either the first analog voltage signal or the second analog voltage signal in accordance with the MSB D5. More specifically, as shown in FIG. 3, the selecting circuit 13 in the present invention has a switch 113A and a switch 113B. The switch 113A is connected to the output of the first D/A converter 11 and a node N16. The switch 113B is connected to the output of the second D/A converter 12 and the node N16. When the MSB D5 is “1”, the switch 113A is closed and the switch 113B is opened. The first analog voltage signal selected in the first D/A converter 11 is thus supplied to the node N16. Meanwhile, when the MSB D5 being “0”, the switch 113A is opened and the switch 113B is closed. Therefore, the second analog voltage signal selected by the second D/A converter 12 is supplied to the node N16. As a result, the selecting circuit 13 supplies the first analog voltage signal or the second analog voltage signal to the node N16 in accordance with the MSB D5.

The selecting circuit 13 deals with all the analog voltage signals V1 to V64. The selecting circuit 13 in the present invention is therefore configured to operate in the third voltage range (see FIG. 2). In the above example, the selecting circuit 13 is configured to operate at least in the voltage range between VDD and VEE. The higher bit D5 supplied to the selecting circuit should be adjusted by a level shift circuit to fit with the third voltage range between VDD and VEE.

The buffer 117 will be described next. The buffer 117 is interposed between the selecting circuit 13 and the output terminal 118 which is aimed for external transmission of the analog voltage signal determined in the selecting circuit 13. More specifically, as shown in FIG. 3, the buffer 117 is interposed between the node N16 and the output terminal 118. The buffer 117 is configured to operate in the third voltage range (see FIG. 2), which is equivalent to the selecting circuit 13. In the above example, the buffer 117 is configured to operate at least in the voltage range between VDD and VEE. The analog voltage signals can be driven at high speed owing to the buffer 117. The buffer 117 is preferable to be a voltage follower, but may be an amplifier with output/input characteristic of “1” or larger.

The precharging circuit 115 will be described next. The precharging circuit 115 in the present invention is connected to the node N16, more precisely, to the outputs of the switch 113A and the switch 113B in the selecting circuit 13. The precharging circuit 115 receives the higher bit group of the digital signal (the MSB D5), and precharges the node N16 to a predetermined voltage in accordance with the higher bit group. In other words, the precharging circuit 115 precharges a line connecting the selecting circuit 13 and the output terminal 118 (the buffer 117) to the predetermined voltage on the basis of the higher bit group.

The purpose of precharging the node N16 to a certain voltage is to prevent the first D/A converter 11 and the second D/A converter 12 from being applied with a voltage higher than the breakdown voltage through the selecting circuit 13. The precharging operation is carried out in the state that the switch 113A and the switch 113B in the selecting circuit 13 are both opened. In other words, after the selecting circuit 13 disconnects an electrical connection between the precharging circuit 115 (the node N16) and the first and second D/A converters 11 and 12, the precharging circuit 115 precharges the node N16 to the certain voltage. The certain voltage is preferable to be either the second voltage or the third voltage. For example, the precharging circuit 115 applies the second voltage to the node N16 when the MSB D5 is “1”, and the precharging circuit 115 applies the third voltage to the node N16 when the MSB D5 is “0”. In the above example, the voltage precharged to the node N16 is the system ground GND. In this case, as shown in FIG. 3, the precharging circuit 115 includes a precharge switch interposed between the ground and the node N16. The precharge switch is controlled based on the higher bit group, and precharges the node N16 to the system ground GND when a value of the higher bit group (the MSB D5) is changed.

The detailed function and effect of the precharging circuit 115 will be described. An operation voltage of the first D/A converter 11 is assumed to be in a range of +3 to 0V (the first voltage range between VDD and GND). An operation voltage of the second D/A converter 12 is also assumed to be in a range of 0 to −3V (the second voltage range between GND and VEE), and the breakdown voltage thereof is assumed to be 4V. In this case, a voltage which is applied to the second D/A converter 12 is limited to +1V or less. When the precharging circuit 115 is not provided, a voltage of +1V or more can be possibly applied to the second D/A converter 12 due to the analog voltage signals V33 to V64 selected in the first D/A converter 11. This will cause an extreme shortening of the component life. According to the present invention, when a value of the higher bit group is changed, the switch 113A and the switch 113B in the selecting circuit 13 are turned off so that the precharging circuit 115 precharges the node N16 to the system ground GND. Therefore, it is possible to prevent the first D/A converter 11 and the second D/A converter 12 from being applied with a voltage higher than the breakdown voltage. The shortening of the component life can be accordingly prevented. It is sufficient that the precharging circuit 115 is configured to operate in the third voltage range (see FIG. 2), which is equivalent to the selecting circuit 13.

An overall operation of the D/A converting circuit 1 in the driver circuit according to the present invention will be described next by referring to FIG. 3. As an example, a case is supposed that a 6-bit digital signals “000000”, “100000” and “111111” are supplied.

Firstly, the digital signal “000000” is supplied. At this time, the higher bit group is “0” and the lower bit group is “00000”. The first D/A converter 11 and the second D/A converter 12 supply the first analog voltage signal V33 and the second analog voltage signal V1 to the selecting circuit 13 in accordance with the lower bit group. In the selecting circuit 13, the switch 113A is turned off and the switch 113B is turned on in accordance with the higher bit group. The second analog voltage signal V1 is thus outputted from the output terminal 118 through the buffer 117.

Secondly, the digital signal “100000” is supplied. At this time, the higher bit group is “1”, and the lower bit group is “00000”. Since the higher bit group (the MSB D5) is changed from “0” to “1”, the switch 113A and the switch 113B in the selecting circuit 13 are turned off, and the precharging circuit 115 precharges the node N16 to the system ground GND. Then, the first D/A converter 11 and the second D/A converter 12 outputs the first analog voltage signal V33 and the second analog voltage signal V1 to the selecting circuit 13 in accordance with the lower bit group. In the selecting circuit 13, the switch 113A is turned on and the switch 113B is turned off in accordance with the higher bit group. The first analog voltage signal V33 is thus outputted from the output terminal 118 through the buffer 117.

Thirdly, the digital signal of “111111” is supplied. At this time, the higher bit group is “1” and the lower bit group is “11111”. Since the higher bit group (the MSB D5) remains the same as “1”, the state of the switch 113A being turned on remains without the precharge operation. That is, when the higher bit group is unchanged, the precharge operation is not carried out since the D/A converters 11 and 12 are not in danger of being applied with a voltage higher than the breakdown voltage. Therefore, it is possible to reduce a useless charging/discharging power consumed by the precharge. The first D/A converter 11 and the second D/A converter 12 supply the first analog voltage signal V64 and the second analog voltage signal V32 to the selecting circuit 13 in accordance with the lower bit group. In the selecting circuit 13, the switch 113A is turned on and the switch 113B is turned off. The first analog voltage signal V64 is thus supplied to the output terminal 118 through the buffer 117.

The analog voltage signals V1, V33 and V64 respectively corresponding to the digital signal “000000”, “100000” and “111111” are thus outputted from the output terminal 118. The D/A converting circuit 1 in the driver circuit according to the present invention exhibits a desired operation as the D/A converting circuit.

In the present invention, the selecting circuit 13, the precharging circuit 115 and the buffer 117 are configured to operate in the third voltage range between VDD and VEE, and formed from high voltage components. The first D/A converter 11 is configured to operate in the first voltage range between VDD and GND as described above. Accordingly, the first D/A converter 11 can be formed from “intermediate voltage components” with a breakdown voltage lower than the high voltage component. The second D/A converter 12 is configured to operate in the voltage range between GND and VEE. Accordingly, the second D/A converter 12 can be formed from the “intermediate voltage components” with a breakdown voltage lower than the high voltage component. Features observed in these different operation voltages and different breakdown voltages will be described below.

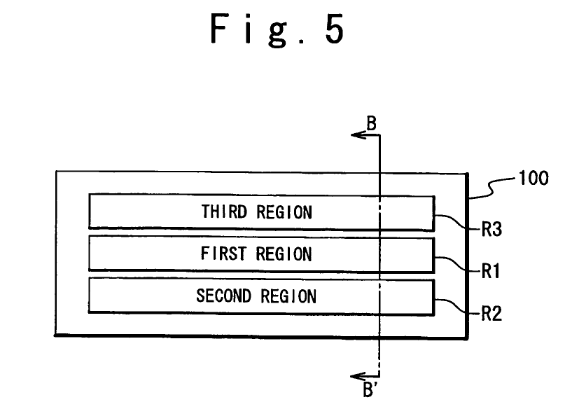

FIG. 5 is a plan view showing an outlined layout of the D/A converting circuit 1 according to the present embodiment. Since operation voltages are different in respective circuits, the circuits with different operation voltages are arranged in different regions on a semiconductor substrate. For example, the first D/A converter 11 operating in the first voltage range between VDD and GND is formed in a first region R1 on a semiconductor substrate 100. The second D/A converter 12 operating in the second voltage range between GND and VEE is formed in a second region R2 on the substrate 100. The selecting circuit 13, the precharging circuit 115 and the buffer 117 that operate in the third voltage range between VDD and VEE are formed in a third region R3 on the substrate 100. The respective regions are divided by using deep wells, and voltages in different ranges are applied to the regions R1, R2 and R3, respectively. When the plurality of D/A converting circuits 1 are formed, the plurality of first D/A converters 11 should be provided in the region R1, the plurality of second D/A converters 12 should be continuously provided in the region R2, and the plurality of selecting circuits 19 should be continuously provided in the region R3.

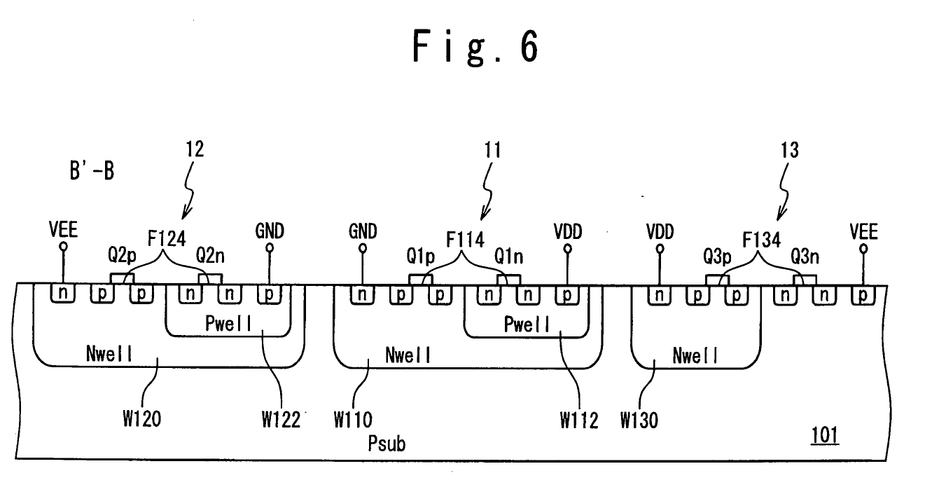

FIG. 6 is a cross sectional view of the semiconductor substrate 100 along the B-B′ line in FIG. 5. A first N well W110, a second N well W120 and a third N well W130 are formed in a P-type substrate 100. The first, second and third regions R1, R2 and R3 correspond to the first, second and third N wells W110, W120 and W130, respectively. In the first N well W110, a P well W112 is formed. The first N well W110 and the P well W112 are applied with the system ground GND and the first voltage VDD, respectively. Moreover, a P channel MOS transistor Q1p is formed on the first N well W110, and an N channel MOS transistor Q1n is formed on the P well W112. Gate electrodes of the respective MOS transistors are formed on the substrate 100 through a gate oxide film F114. The first D/A converter 11 operating in the first voltage range between VDD and GND is configured of the MOS transistors Q1p and Q1n. Therefore, the MOS transistors Q1p and Q1n are intermediate voltage components. In the second N well W120, a P well W122 is formed. The second N well W120 and the P well W122 are applied with the fourth voltage VEE and the system ground GND, respectively. Moreover, a P channel MOS transistor Q2p is formed on the second N well W120, and an N channel MOS transistor Q2n is formed on the P well W122. Gate electrodes of the respective MOS transistors are formed on the substrate 100 through a gate oxide film F124. The second D/A converter 12 operating in the second voltage range between GND and VEE is configured of the MOS transistors Q2p and Q2n. Therefore, the MOS transistors Q2p and Q2n are intermediate voltage components. The third N well W130 and the P type substrate 100 are applied with the first voltage VDD and the fourth voltage VEE, respectively. The third N well W130 may be applied with a voltage higher than the first voltage VDD and the P type substrate 100 may be applied with a voltage lower than the fourth voltage VEE. Moreover, a P channel MOS transistor Q3p is formed on the third N well W130, and an N channel MOS transistor Q3n is formed on the P type substrate 100. Gate electrodes of the respective MOS transistors are formed on the substrate 100 through a gate oxide film F134. The selecting circuit 13, the precharging circuit 115 and the buffer 117 that operate in the third voltage range between VDD and VEE are configured of the MOS transistors Q3p and Q3n. Therefore, the MOS transistors Q3p and Q3n are high voltage components.

A breakdown voltage of the MOS transistors Q1p, Q1n, Q2p and Q2n that are the intermediate voltage components may be lower than that of the MOS transistors Q3p and Q3n. Therefore, the gate oxide films F114 and F124 of the MOS transistors formed in the first and second regions R1 and R2 can be designed to be thinner than the gate oxide film F134 of the MOS transistors formed in the third region R3. A gate length L of the MOS transistors formed in the first and second regions R1 and R2 can also be designed to be shorter than that of the MOS transistors formed in the third region R3. Further, a gate width W of the MOS transistors formed in the first and second regions R1 and R2 can be designed to be narrower than that of the MOS transistors formed in the third region R3. In other words, according to the present invention, it is possible to reduce the circuit areas of the first D/A converter 11 and the second D/A converter 12. As a result, the D/A converting circuit 1 has a smaller circuit area than that of the conventional circuits.

As described above, according to the present invention, the first D/A converter 11 and the second D/A converter 12 are formed of intermediate voltage components. Therefore, reduction of the circuit area in the D/A converting circuit 1 is realized. The area of a D/A converting circuit is, in general, enlarged in accordance with the increase of the number of bits in the digital signal. Accordingly, the D/A converting circuit 1 in the driver circuit according to the present invention is suitable particularly when the number of bits is many.

The operation voltage in the first D/A converter 11 and the second D/A converter 12 is reduced, so that it is possible to reduce the consumed power in the D/A converting circuit 1. The precharging circuit 115 prevents the first D/A converter 11 and the second D/A converter 12 from being applied with voltages higher than the breakdown voltage, and also prevents the shortening of the component life. The precharging circuit 115 is preferable to carry out the precharging operation only when the value of the higher bit group is changed. Thus, the useless charging/discharging power used for the precharging operation can be thus reduced.

An example of a semiconductor device to which the D/A converting circuit 1 in the driver circuit according to the present invention is applied will be described below in detail. The D/A converting circuit 1 in the driver circuit according to the present invention is used in the driver circuit to drive a display apparatus for displaying digital image data. In this case, the above-described digital signal D0 to D5 is displayed as a pixel data on a pixel of a display panel. The analog voltage signals V1 to V64 are gradation signals indicating pixel voltages (gradation voltages) applied to the pixel of the display panel. The D/A converting circuit 1 converts the pixel data to the gradation signal. Examples of the display apparatus include a liquid crystal display apparatus, a plasma display apparatus, and an organic EL display apparatus. The liquid crystal display apparatus will be used as an example in the following explanation.

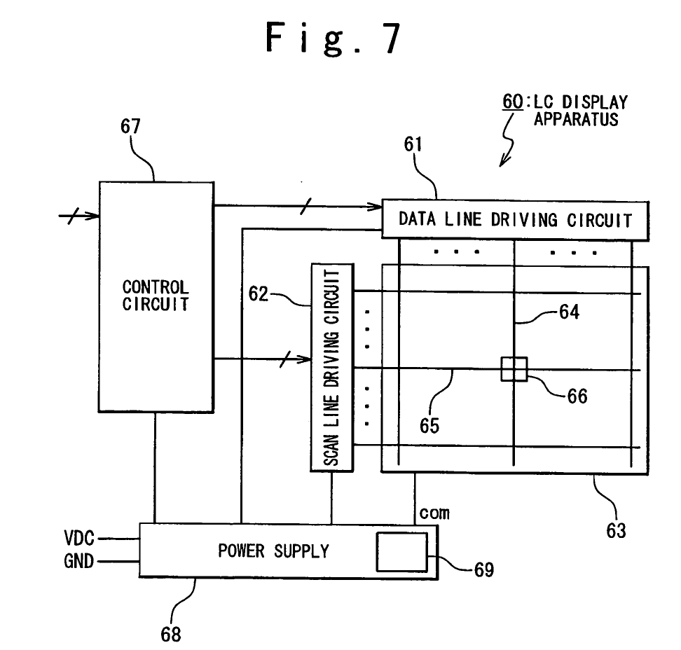

FIG. 7 is a block diagram showing a configuration of a liquid crystal display apparatus 60 according to the present invention. The liquid crystal display apparatus 60 includes a data line driver circuit 61, a scanning line driver circuit 62, a display panel 63, a control circuit 67 and a power source circuit 68.

In the display panel 63, a plurality of data lines 64 are connected to the data line driver circuit 61 and a plurality of scanning lines 65 are connected to the scanning line driver circuit 62. A plurality of the data lines 64 and the plurality of scanning lines 65 are formed to cross to each other, and a plurality of pixels 66 are formed on a plurality of cross points, respectively. More specifically, the display panel 63 has the plurality of pixels 66 (e.g., 1080×1920 pixels 66) that are disposed in a matrix form. The pixels 66 respectively have a TFT (Thin Film Transistor), liquid crystal and a common electrode. A gate terminal of the TFT is connected to the scanning line 65 and a source terminal or a drain terminal of the TFT is connected to the data line 64. One of the ends of liquid crystal is connected to the source terminal or the drain terminal of the TFT, and the other end of the liquid crystal is connected to the common electrode which is applied with a certain constant common voltage.

The control circuit 67 outputs a scanning line driving signal group to the scanning line driver circuit 62. The scanning line driver circuit (gate driver) 62 sequentially drives a plurality of scanning lines 65 in accordance with the scanning line driving signal group. The control circuit 67 also outputs a data line driving signal group and a digital video signal to the digital line driver circuit 61. The data line driver circuit (source driver) 61 drives the plurality of data lines 64 in accordance with the data line driving signal group. More specifically, the data line driver circuit 61 outputs a gradation signal (analog voltage signal) to the plurality of data lines 64 in accordance with the digital video signal. Thus, the plurality of pixels 66 connected to a selected one of the scanning lines 65 are applied with gradation voltages (pixel voltage) in accordance with the video signal, respectively. A plurality of scanning lines 65 are sequentially driven to display an image on the display panel 63.

The power source circuit 68 generates an operation voltage for the data line driver circuit 61 and the scanning line driver circuit 62 from a power source voltage VDC provided to the liquid crystal display apparatus 60. The power source circuit 68 also has a common voltage generating circuit 69. The common voltage generating circuit 69 supplies a common voltage to the common electrode.

The D/A converting circuit 1 is applied to the data line driver circuit 61 of the present invention for outputting a gradation signal (analog voltage signal) to the data lines 64. The plurality of D/A converting circuits 1 are provided to drive the plurality of data lines 64. The D/A converting circuit 1 with a reduced circuit area of the present invention is therefore suitable particularly for the data line driver circuit 61 requiring a number of D/A converting circuits.

### First Embodiment

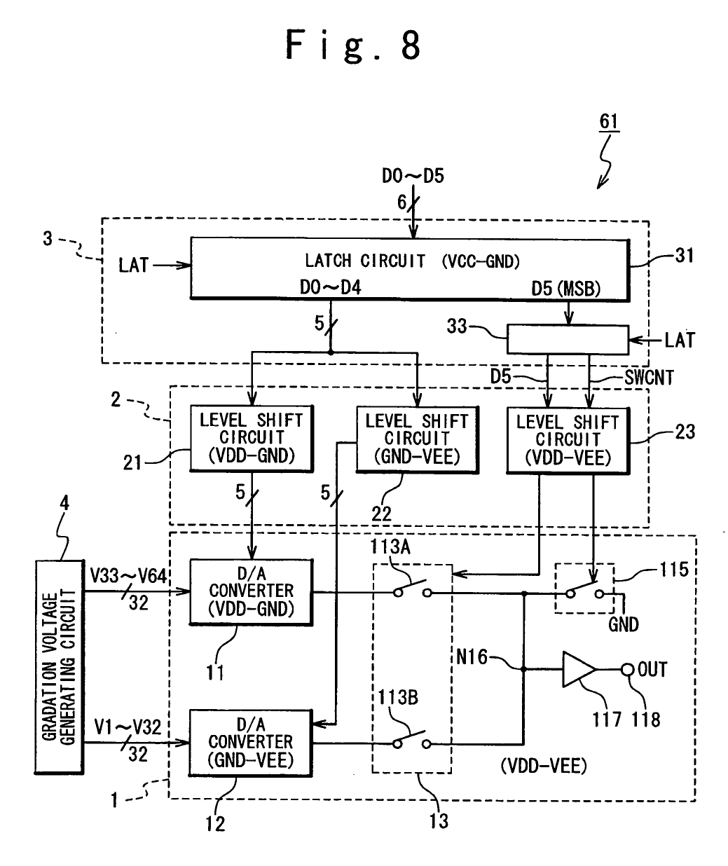

FIG. 8 is a block diagram showing a configuration of the data line driver circuit 61 according to a first embodiment of the present invention. The data line driver circuit 61 in the first embodiment includes the D/A converting circuit 1 shown in FIG. 3, a level shift circuit group 2, a logic circuit 3 and a gradation voltage generating circuit 4. The output terminal 118 of the D/A converting circuit 1 is connected to one of the plurality of data lines 64. One gradation signal (analog voltage signal) selected by the D/A converting circuit 1 is supplied to the data line 64 and the certain pixel 66 through the output terminal 118. Although only one D/A converting circuit 1 is shown in FIG. 8, the plurality of D/A converting circuits 1 are installed for the plurality of data lines 64 in practical use.

First, the gradation voltage generating circuit 4 will be described. The gradation voltage generating circuit 4 is configured to supply the plurality of gradation signals (the analog voltage signals) V1 to V64 to the D/A converting circuit 1. The gradation voltage generating circuit 4 is connected to the D/A converting circuit 1, and supplies the gradation signals V33 to V64 corresponding to the first voltage range between VDD and GND to the first D/A converter 11, and the gradation signals V1 to V32 corresponding to the second voltage range between GND and VEE to the second D/A converter 12. The gradation voltage generating circuit 4 is preferably installed in common to the plurality of D/A converting circuits 1 in order to prevent a deviation between the D/A converting circuits 1.

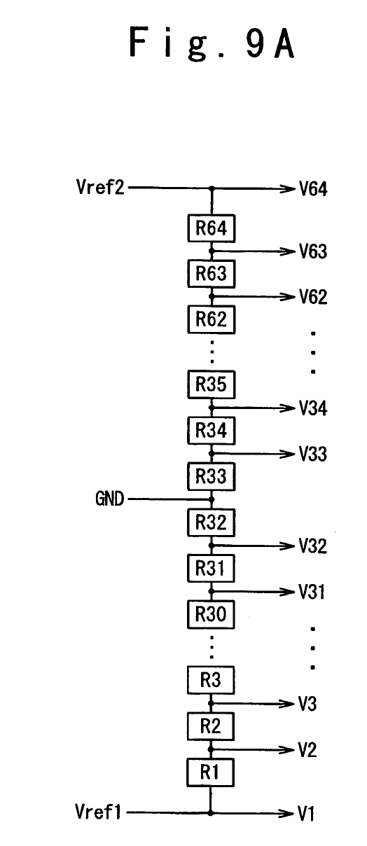

In the first embodiment, the gradation voltage generating circuit 4 is configured of a resistor string circuit which is excellent in the monotonically increasing characteristic. FIG. 9A shows an example of the resistor string circuit, in which a plurality of resistors R1 to R64 are connected in series. The resistor string circuit is supplied with reference voltages Vref1 and Vref2 and GND, and the plurality of gradation voltages V1 to V64 are generated from the respective connection points between the resistors. In this case, the gradation voltages V32 and V33 in the intermediate tone have a voltage adjacent to the system ground GND. FIG. 9B shows another resistor string circuit in which the plurality of resistors R1 to R63 are connected in series. The resistor string circuit is supplied with the reference voltages Vref1 and Vref2 and the GND in which the plurality of gradation voltages V1 to V64 are generated from the respective connection points between the resistors. In this case, the gradation voltage V32 in the intermediate tone is the system ground GND. The gradation voltages V64 to V33 are gradation voltages for the first voltage range between VDD to GND, and supplied to the first D/A converter 11. The gradation voltages V32 to V1 are gradation voltages for the second voltage range between GND and VEE, and supplied to the second D/A converter 12.

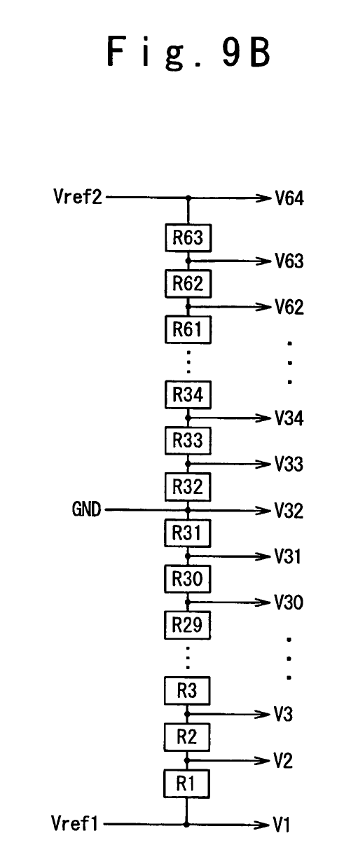

FIG. 10 shows a corresponding relation between the gradation voltage and a gradation in the pixels 66. In case of the gradation voltage and the gradation having a linear relation as shown by a solid line in FIG. 10, the plurality of resistors (R1 to R64) are designed to have an identical resistance. Correction of the corresponding relation between the gradation voltage and the gradation may be carried out to adjust a difference between light transmittance characteristic of a liquid crystal material and a visual characteristic of a human being so that a natural gradation display is provided. This correction is called a gamma correction. In this case, the corresponding relation between the gradation voltage and the gradation is set to be nonlinear as shown by a dotted line in FIG. 10. In order to carry out the gamma correction, resistances of the plurality of resistors (R1 to R64) should be adjusted to have a function shown by the dotted line in FIG. 10. A buffer such as a voltage follower that is not shown may be interposed between the gradation voltage generating circuit 4 and the first and second D/A converters 11 and 12. In this case, the above-mentioned buffer 117 may be omitted.

The logic circuit 3 will be described next. The logic circuit 3 receives the digital signal D0 to D5 for pixel data, and supplies the higher bit group D5 and the lower bit group D0 to D4 to the D/A converting circuit 1. More specifically, the logic circuit 3 includes a latch circuit 31 to latch the 6-bit digital signal D0 to D5 in response to a latch signal LAT. The latch circuit 31 outputs the lower bit group D0 to D4 of the digital signal to the first D/A converter 11 and the second D/A converter 12. The latch circuit 31 also outputs the higher bit group D5 of the digital signal to the selecting circuit 13 and the precharging circuit 115. The D/A converting circuit 1 carries out the above operation in response to the higher bit group D5 and the lower bit group D0 to D4. The logic circuit 3 according to the first embodiment may include a change detecting circuit 33 as shown in FIG. 8. The change detecting circuit 33 controls a precharging operation, and detects a value change for the higher bit group D5 of the digital signal. The change detecting circuit 33 is composed of a logic circuit such as EXOR circuits and a latch circuit to detect the variation of a value of the higher bit group D5. When the variation of the value of the higher bit group 5 is detected, the change detecting circuit 33 outputs a switch control signal SWCNT to the selecting circuit 13 and the precharging circuit 115 in the period that the latch signal LAT is in the high level. The selecting circuit 13 temporarily turns off the switch 113A and switch 113B in response to the switch control signal SWCNT. At the same time, the precharging circuit 115 precharges the node N16 to the system ground GND in response to the switch control signal SWCNT. The change detecting circuit 33 may be installed in the selecting circuit 13 and the precharging circuit 115, instead of being installed in the logic circuit 3. The latch circuit 31 in the first embodiment is configured to operate in a voltage range between a voltage VCC and the ground voltage GND. The voltage VCC is, for example, 2V which is different from the voltage VDD (e.g., +3V) and the voltage VEE (e.g., −3V). In this case, the voltage of the digital signal D0 to D5 supplied to the latch circuit 31 is between the voltage VCC and the ground voltage GND. According to the first embodiment, a level shift circuit group 2 is interposed between the logic circuit 3 and the D/A converting circuit 1 in order to adjust the voltage of the digital signal D0 to D5 supplied from the latch circuit 31 to fit with the operation voltage of the D/A converting circuit 1.

As shown in FIG. 8, the level shift circuit group 2 includes a first level shift circuit 21, a second level shift circuit 22 and a third level shift circuit 23. The first level shift circuit 21 is interposed between the latch circuit 31 and the first D/A converter 11. The first level shift circuit 21 receives the lower bit group D0 to D4 from the latch circuit 31, and converts the lower bit group to fit in the first voltage range between VDD (3V) and GND. The first level shift circuit 21 outputs the level-shifted lower bit group D0 to D5 to the first D/A converter 11. The second level shift circuit 22 is interposed between the latch circuit 31 and the second D/A converter 12. The second level shift circuit 22 receives the lower bit group D0 to D4 from the latch circuit 31, and converts the lower bit group to fit in the second voltage range between GND and VEE (−3V). The second level shift circuit 22 outputs the level-shifted lower bit group D0 to D5 to the second D/A converter 12. The third level shift circuit 23 is interposed between the logic circuit 3 (the change detecting circuit 33) and a set of the selecting circuit 13 and the precharging circuit 115. The third level shift circuit 23 receives the higher bit group D5 from the logic circuit 3, or receives the switch control signal SWCNT from the change detecting circuit 33. The third level shift circuit 23 converts the higher bit group D5 or the switch control signal SWCNT to fit with the third voltage range between VDD (3V) and VEE (−3V). Thereafter, the third level shift circuit 23 outputs the level-shifted higher bit group D5 or the switch control signal SWCNT to the selecting circuit 13 and the precharging circuit 115.

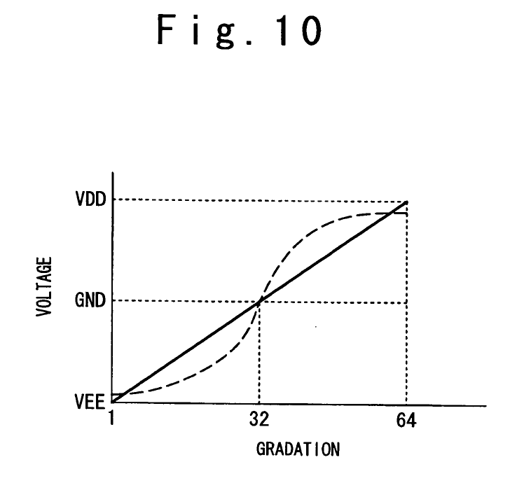

FIG. 11 shows an example of the configuration of the first level shift circuit 21 and the second level shift circuit 22. The first level shift circuit 21 is a well-known level shifter which includes channel transistors P1 and P2 as well as N channel transistors M1 and M2. The first level shift circuit 21 is configured to operate in a voltage range between the first voltage VDD (3V) and the second voltage GND. Therefore, the first level shift circuit 21 is of an intermediate voltage type, and the transistors P1, P2, M1 and M2 are intermediate voltage components. The second level shift circuit 22 includes a well-known level shifter of P channel transistors P3 and P4 and N channel transistors M3 and M4, and a well-known level shifter of P channel transistors P5 and P6 and N channel transistors M5 and M6. The second level shift circuit 22 is configured to operate in a voltage range between the voltage VCC (2V) and the fourth voltage VEE (−3V). Therefore, the second level shift circuit 22 is of a high voltage type, and the transistors P3 to P6 and M3 to M6 are high voltage components.

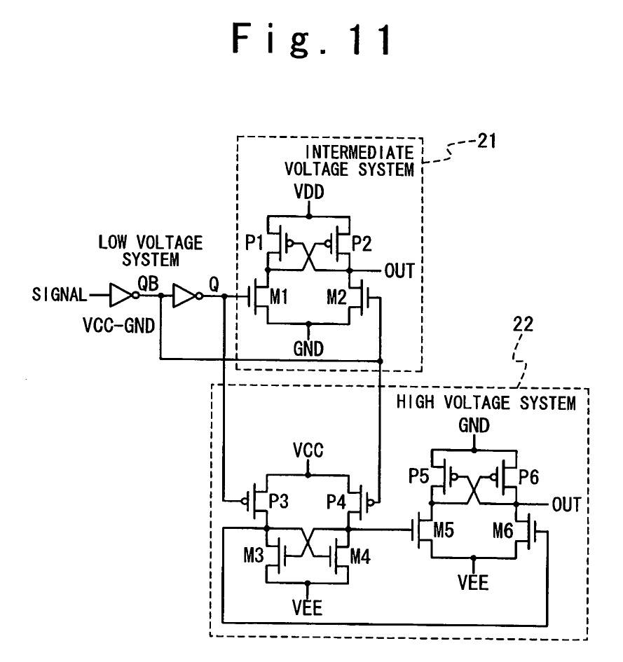

FIG. 12 shows an example of the configuration of the third level shift circuit 23. The third level shift circuit 23 includes a well-know level shifter of P channel transistors P7 and P8 and N channel transistors M7 and M8, and a well-known level shifter of P channel transistors P9 and P10 and N channel transistors M9 and M10. The third level shift circuit 23 is configured to operate in a voltage range between the first voltage VDD (3V) and the fourth voltage VEE (−3V). Therefore, the third level shift circuit 23 is of a high voltage type, and the transistors P to P10 and M7 to M10 are high voltage components

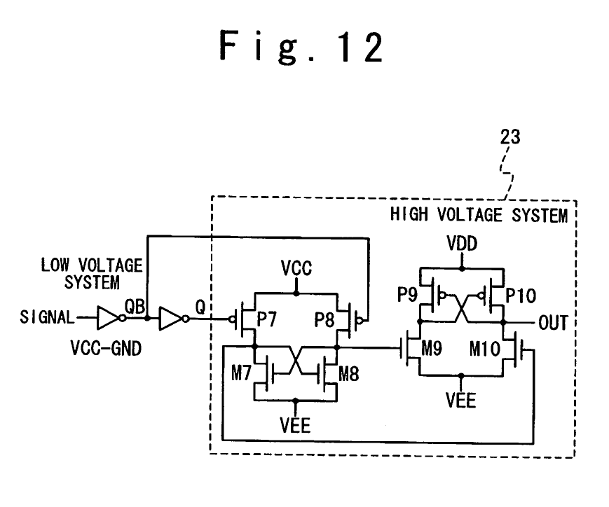

An overall operation of the data line driver circuit 61 according to the first embodiment will be described next. FIGS. 13A to 13C are timing charts showing an example of an operation of the data line driver circuit 61. Firstly, the digital signal “000000” is supplied to the D/A converting circuit 1 and the gradation voltage V1 is outputted from the output terminal 118 (OUT) of the D/A converting circuit 1. Thereafter, the latch signal LAT goes to the high level from the low level, and the latch circuit 31 latches the digital signal “111111”. At this time, the higher bit group D5 has been changed from “0” to “1”, and the change detecting circuit 33 outputs the switch control signal SWCNT to the selecting circuit 13 and the precharging circuit 115. In the period that the latch signal LAT is in the high level, the selecting circuit 13 turns off the switch 113A and the switch 113B, and the precharging circuit 115 precharges the node N16 to the system ground GND. At this time, the output terminal 118 outputs the system ground GND. In case of the latch signal LAT being changed from the high level to the low level, the change detecting circuit 33 suspends the output of the switch control signal SWCNT. The selecting circuit 13 turns on the switch 113A in accordance with the higher bit group D5. The output terminal 118 therefore outputs the gradation voltage V64. Thus, the precharging operation eliminates a possibility that the second D/A converter 12 is applied with the gradation voltage 64.

Next, the latch signal LAT goes to the high level from the low level, and the latch circuit 31 latches the digital signal “110000”. At this time, the higher bit group D5 remains as “1”, and therefore the precharging operation is not carried out while the switch 113A remains in the state of being turned on. The output terminal 118 outputs the gradation voltage V49 in accordance with the digital signal. The precharging operation is not carried out when there is no change in the higher bit group, which will cause a reduction of a useless charging/discharging power.

Next, the latch signal LAT goes to the high level from the low level, and the latch circuit 31 latches the digital signal “010000”. At this time, the higher bit group D5 has been changed from “1” to “0”, and therefore the precharging operation is carried out. In the period that the latch signal LAT is in the high level, the output terminal 118 outputs the system ground GND. When the latch signal LAT is changed to the low level from the high level, the selecting circuit 13 turns on the switch 113B in accordance with the higher bit group D5. Thus, the output terminal 118 outputs the gradation voltage V17. The latch circuit 31 latches the digital signal “000000” next, and the output terminal 118 outputs the gradation voltage V1.

In the first embodiment, the logic circuit 3 such as the latch circuit 31 and the change detecting circuit 33 is configured to operate in the voltage range between VCC and GND, and formed from a low voltage component (e.g., 2V). The first D/A converter 11 is configured to operate in the first voltage range between VDD and GND, and formed from intermediate voltage components (e.g., 3V). The second D/A converter 12 is configured to operate in the second voltage range between GND and VEE, and formed from the intermediate voltage components. The first level shift circuit 21 is configured to operate in the first voltage range between VDD and GND, and formed from the intermediate voltage components. The second level shift circuit 22 is configured to operate, at least, in the voltage range between VCC and VEE, and formed from the high voltage components (e.g., 6V). The third level shift circuit 23, the selecting circuit 13, the precharging circuit 115 and the buffer 117 are configured to operate in the third voltage range between VDD and VEE, and formed from the high voltage component. When a buffer is installed in the gradation voltage generating circuit 4, the buffer is preferable to be formed from the intermediate voltage components.

Referring to FIG. 5, the first D/A converter 11 and the first level shift circuit 21 operate in the first voltage range between VDD and GND and are formed in the first region R1. The second D/A converter 12 operates in the second voltage range between GND and VEE and is formed in the second region R2. The second level shit circuit 22, the third level shift circuit 23, the selecting circuit 13, the precharging circuit 115 and the buffer 117 operate in the third voltage range between VDD and VEE and are formed in the third region R3 on the substrate 100. The logic circuit 3 operates in the voltage range between VCC and GND and is formed in the fourth region R4 (not shown). In case of forming the plurality of D/A converting circuits 1, the plurality of first D/A converters 11 should be continuously provided in the region R1, the plurality of second D/A converters 12 should be continuously provided in the region R2, and the plurality of selecting circuits 19 should be continuously provided in the region R3.

As shown in FIG. 6, the respective regions R1, R2 and R3 are divided by the deep well layers W110, W120 and W130, and applied with different-ranged voltages. In FIG. 6, the third region R3 is applied with the first voltage VDD (3V) and the fourth voltage VEE (−3V), and may be applied with a voltage of the first voltage VDD or higher and a voltage of the fourth voltage VEE or lower. For example, the data line driver circuit 61 and the scanning line driver circuit 62 may be formed on the same substrate 100, and a voltage used to operate the scanning line driver circuit 62 (e.g., −5V to 5V) may be applied to the third region R3.

According to the present embodiment, the intermediate voltage components formed in the first region R1 and the second region R2 can be designed to be smaller than the high voltage components. More specifically, the gate oxide films F114 and F124 of the MOS transistors formed in the first region R1 and the second region R2 are designed to be thinner than the gate oxide film F134 of the MOS transistor formed in the third regions R3. Moreover, the gate length L of the MOS transistors formed in the first region R1 and the second region R2 is designed to be shorter than the gate length L of the MOS transistor formed in the third region R3. Further, the gate width W of the MOS transistors formed in the first region R1 and the second region R2 is designed to be smaller than the gate width W of the MOS transistor formed in the third region R3. Reduction of the circuit area in the D/A converting circuit 1 is thus realized, and reduction of the circuit area in the data line driver circuit 61 is also realized. The low voltage component formed in the fourth region (not shown) can be designed to be smaller than the intermediate voltage components.

As described above, according to the present embodiment, the first D/A converter 11 and the second D/A converter 12 are formed of intermediate voltage components. Therefore, the reduction of the circuit area in the D/A converting circuit 1 is achieved and the reduction of the circuit area in the data line driver circuit 61 is achieved. The configuration in the present invention is suitable for the data line driver circuit 61 which requires a large number of the D/A converting circuits 1. In general, the circuit area of a D/A converting circuit is expanded and the area of the data line driver circuit is also expanded, in accordance with the increase of the number of bits of the digital signal. Accordingly, the data line driver circuit 61 according to the first embodiment is suitable particularly for large bit numbers.

The operation voltage in the first D/A converter 11 and the second D/A converter 12 is also reduced, which will cause a reduction of power consumption in the D/A converting circuit 1 and in the data line driver circuit 61. The precharging circuit 115 prevents the first D/A converter 11 and the second D/A converter 12 from being applied with a voltage higher than the breakdown voltage, and prevents the shortening of component life. The precharging circuit 115 is preferable to carry out the precharging operation only when the value of the higher bit group is changed. Therefore, it is possible to reduce the useless charging/discharging power used in the precharging operation.

Moreover, as described above, the second voltage and the third voltage are preferable to be the system ground GND. The reason is as follows. That is, it is assumed that the power source voltage VDC of the liquid crystal display apparatus 60 (see FIG. 7) is 3V, and the data line driver circuit 61 operates in a voltage range between 6V and 0V as the third voltage range between VDD and VEE. In this case, the power source circuit 68 is required to boost the power source voltage VDC for generating the voltage of 6V. Efficiency in a boosting circuit at this time is about 80%. However, when the data line driver circuit 61 operates in a voltage range between 3V and −3V as the third voltage range between VDD and VEE, the power source circuit 68 is not required to boost the power source voltage VDC. The power source circuit 68 employs the system ground GND as a reference, and generates the power source voltage of the data line driver circuit 61 from the power source voltage VDC. In this case, a loss in the boost circuit is not observed, and the power consumption is reduced. It is thus possible to reduce the power consumption of the liquid crystal display apparatus 60 by setting the second voltage and the third voltage to the system ground GND.

### Second Embodiment

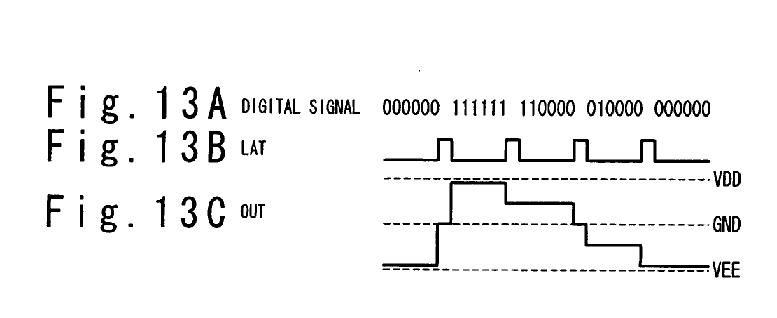

When a voltage range in which the logic section 3 operates is identical to a voltage range in which the first D/A converter 11 or the second D/A converter 12 operate, the first level shift circuit 21 or the second level shift circuit 22 can be omitted. FIG. 14 shows the configuration of a data line driver circuit 61a when the logic section 3 operates in the first voltage range between VDD and GND in the same manner with the first D/A converter 11. In FIG. 14, the same reference numerals are allocated to the components equivalent to FIG. 8, and the description thereof is omitted as appropriate. A level shift circuit group 2a of the data line driver circuit 61a according to the second embodiment includes the second level shift circuit 22 and the third level shift circuit 23. The first level shift circuit 21 is omitted, and the lower bit group D0 to D4 is directly supplied to the first D/A converter 11 from the latch circuit 31. Therefore, the circuit area of the data line driver circuit 61a is further reduced.

### Third Embodiment

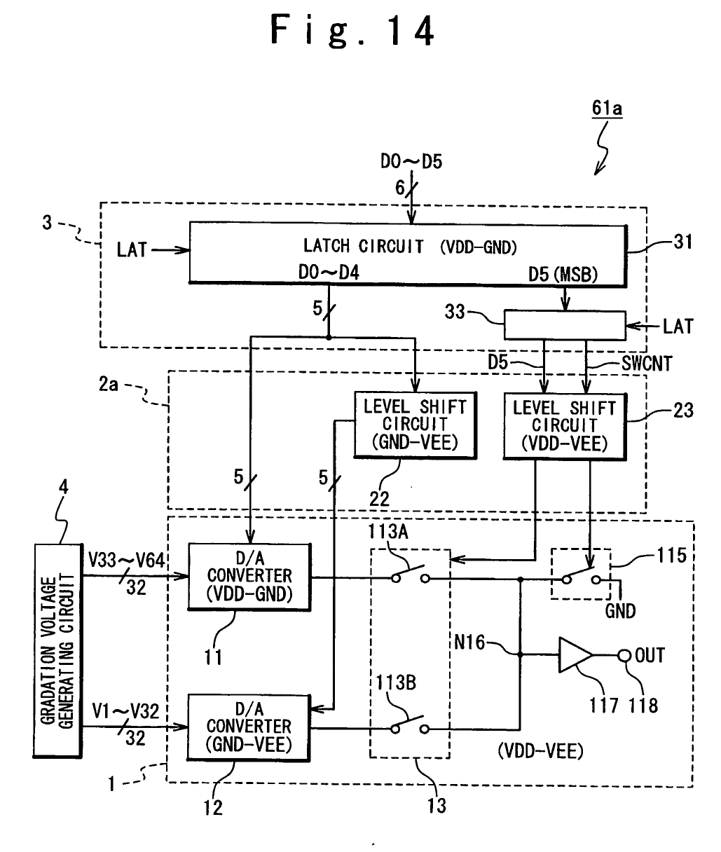

It is possible that the data line driver circuit 61 carries out the precharge operation in place of the precharging circuit 115. FIG. 15 shows a configuration of a data line driver circuit 61b according to the third embodiment of the present invention. In FIG. 15, the same reference numerals as in FIG. 8 are allocated to the same components, and the description thereof is omitted as appropriate. The data line driver circuit 61b according to the third embodiment includes a D/A converting circuit 1b, the level circuit group 2, and a logic circuit 3b. The D/A converting circuit 1b is equivalent to the D/A converting circuit 1 according to the first embodiment, except that the D/A converting circuit 1b does not include the precharging circuit 115.

The logic circuit 3b according to the third embodiment includes the latch circuit 31, logic circuits 34 and 35 and a change detecting circuit 36. The logic circuit 34 supplies the lower bit group D0 to D4 received from the latch circuit 31 to the first D/A converter 11 through the first level shift circuit 21. The logic circuit 35 supplies the lower bit group D0 to D4 received from the latch circuit 31 to the second D/A converter 12 through the second level shift circuit 22.

The change detecting circuit 36 receives the higher bit group D5 of the digital signal from the latch circuit 31, and supplies the higher bit group D5 through the third level shift circuit 23 to the selecting circuit 13. The level detecting circuit 36 also detects the change of a value of the higher bit group D5. The change detecting circuit 36 is configured of logic circuits such as an EXOR circuit and a latch circuit to detect the change of the higher bit group D5. In case of detecting the change of the value in the higher bit group D5, the change detecting circuit 36 outputs the control signal CNT to the logic circuits 34 and 35 in the logic circuit 3b. When the value of the higher bit group D5 is changed, at least one of the logic circuits 34 and 35 carries out the following operation to precharge the node N16 to a voltage adjacent to the system ground GND. In other words, the logic circuit 34 temporarily supplies data “100000” as the lower bit group D0 to D4 to the first D/A converter 11 in response to the control signal CNT. Thus, the first D/A converter 11 selects the gradation voltage V33 and precharges the node N16 to the gradation voltage V33. Meanwhile, the logic circuit 35 temporarily supplies data “11111” as the lower bit group D0 to D4 to the second D/A converter 12 in response to the control signal CNT. Thus, the second D/A converter 12 selects the gradation voltage V32 and precharges the node N16 to the gradation voltage V32.

According to the third embodiment, when the higher bit group D5 is changed, the node N16 is precharged to the gradation voltage V32 or V33 that are adjacent to the system ground GND. Accordingly, the first D/A converter 11 and the second D/A converter 12 are prevented from being applied with a voltage higher than the breakdown voltage.

### Fourth Embodiment

In the above embodiments, the higher bit group includes the MSB D5, and the lower bit group includes the bits D0 to D4. When a plurality of bits are included in the higher bit group, the D/A converting circuit according to the present invention can be realized on the basis of an idea equivalent to the above embodiments. As an example, a case where the higher bit group includes the bits D5 and D4, and the lower bit group includes the bits D0 to D3 will be described below.

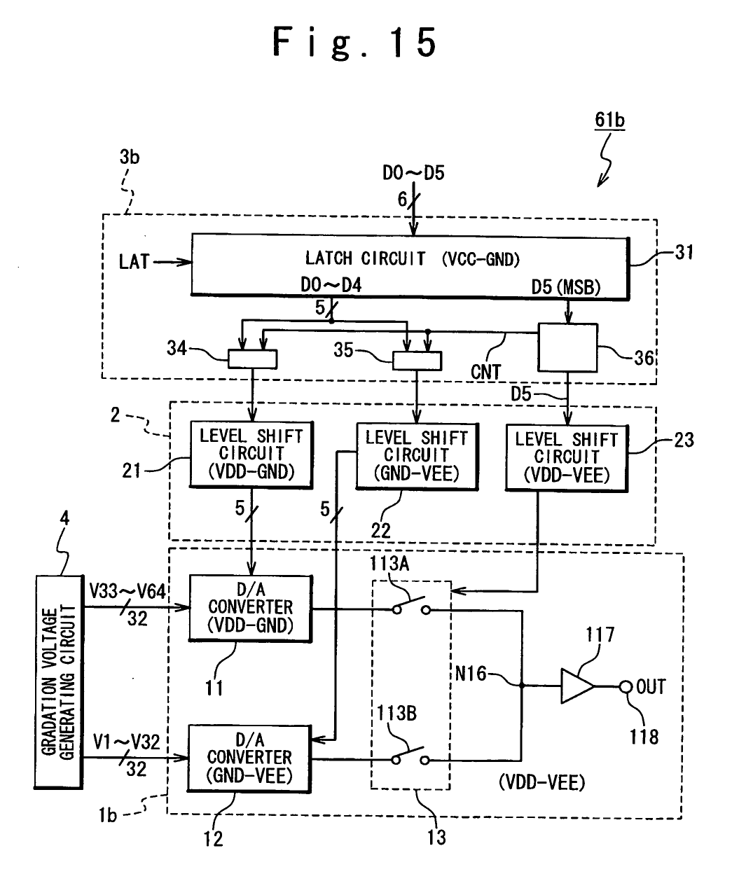

FIG. 16 shows a D/A converting circuit 1′ and the gradation voltage generating circuit 4 according to the fourth embodiment of the present invention. In FIG. 16, the same reference numerals as in FIG. 8 are allocated to the same components, and the description thereof is omitted as appropriate. The D/A converting circuit 1′ according to the fourth embodiment includes a first higher D/A converter 11A, a first lower D/A converter 11B, a second higher D/A converter 12A, a second lower D/A converter 12B, a selecting circuit 13′, a precharging circuit 115′, the buffer 117 and the output terminal 118.

The first higher D/A converter 11A is configured to operate in a voltage range between a fifth voltage VFF and the first voltage VDD. The first voltage VDD is lower than the fifth voltage VFF. The gradation voltage generating circuit 4 supplies the plurality of gradation signals V49 to V64 corresponding to the voltage range between the fifth voltage VFF and the first voltage VDD to the first higher D/A converter 11A. The first higher D/A converter 11A supplies one gradation signal selected from among the plurality the gradation signals V49 to V64 as a first gradation signal, to the selecting circuit 13′ in accordance with the lower bit group D0 to D3. The first lower D/A converter 11B is configured to operate in a voltage range between the first voltage VDD and the second voltage GND. The second voltage GND is lower than the first voltage VDD. The gradation voltage generating circuit 4 supplies the plurality of gradation signals V33 to V48 corresponding to the voltage range between the first voltage VDD and the second voltage GND to the first lower D/A converter 112B. The first lower D/A converter 11B supplies one gradation signal selected from among the plurality the gradation signals V33 to V48 as a second gradation signal, to the selecting circuit 13′ in accordance with the lower bit group D0 to D3. The second higher D/A converter 12A is configured to operate in a voltage range between the third voltage GND and the fourth voltage VEE. The fourth voltage VEE is lower than the third voltage GND. The gradation voltage generating circuit 4 supplies the plurality of gradation signals V17 to V32 corresponding to the voltage range between the third voltage GND and the fourth voltage VEE to the second higher D/A converter 12A. The second higher D/A converter 12A supplies one gradation signal selected from among the plurality the gradation signals V17 to V32 as a third gradation signal to the selecting circuit 13′ in accordance with the lower bit group D0 to D3. The second lower D/A converter 12B is configured to operate in a voltage range between the fourth voltage VEE and a sixth voltage VGG. The sixth voltage VGG is lower than the fourth voltage VEE. The gradation voltage generating circuit 4 supplies the plurality of gradation signals V1 to V16 corresponding to the voltage range between the fourth voltage VEE and the sixth voltage VGG to the second lower D/A converter 57. The second lower D/A converter 57 supplies one gradation signal selected from among the plurality the gradation signals V1 to V16 as a fourth gradation signal to the selecting circuit 13′ in accordance with the lower bit group D0 to D3.

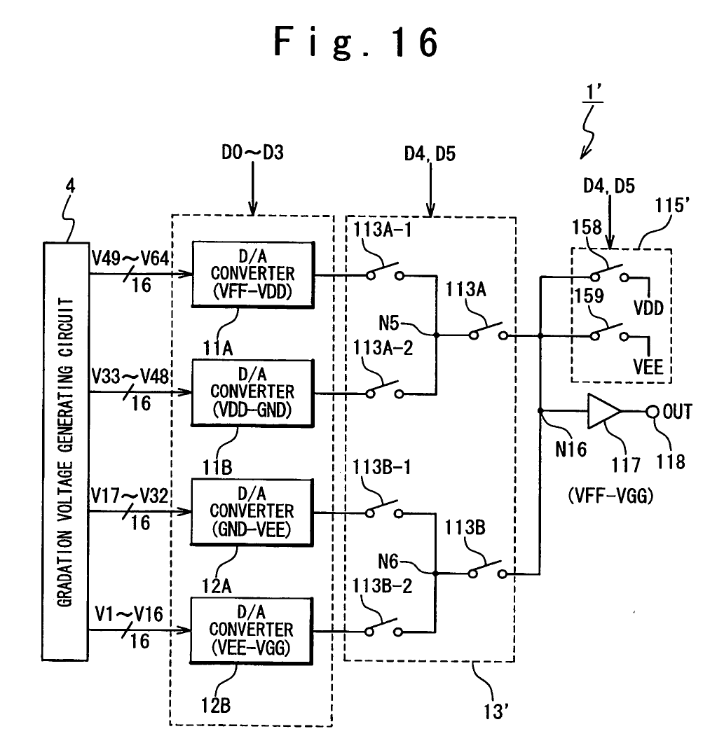

FIG. 17 shows a corresponding relation between a gradation voltage and a gradation in the pixels 66. As an example of the fifth voltage VFF, +4V is shown, and as an example of the first voltage VDD, +2V is shown. The system ground GND is shown as the second voltage and the third voltage. As an example of the fourth voltage VEE, −2V is shown, and as an example of the sixth voltage VGG, −4V is shown. In this case, the D/A converters 11A to 12B can be formed from low voltage components. More specifically, according to the fourth embodiment, the circuit area of the D/A converting circuit 1′ can be further reduced, which is smaller than the D/A converting circuit 1.

Besides, as shown in FIG. 16, the selecting circuit 13′ according to the fourth embodiment includes the switches 113A and 113B controlled by the MSB D5 of the higher bit group, and switches 113A-1 to 113B-2 controlled by the higher bit D4 of the higher bit group. The respective switches in the selecting circuit 13′ operate in a voltage range between the fifth voltage VFF or a higher voltage and the sixth voltage VGG or a lower voltage. The switch 113A-1 is interposed between the first higher D/A converter 11A and a node N5, and receives the first gradation signal from the first higher D/A converter 11A. The switch 113A-2 is interposed between the first lower D/A converter 11B and the node N5, and receives the second gradation signal from the first lower D/A converter 11B. The switches 113A-1 and 113A-2 supply the first gradation signal or the second gradation signal as a high gradation signal to the node N5 on the basis of the value of the higher bit D4. The switch 113B-1 is interposed between the second higher D/A converter 12A and a node N6, and receives the third gradation signal from the second higher D/A converter 12A. The switch 113B-2 is interposed between the second lower D/A converter 12B and the node N6, and receives the fourth gradation signal from the second lower D/A converter 12B. The switches 113B-1 and 113B-2 outputs the third gradation signal or the fourth gradation signal to the node N6 as a low gradation signal on the basis of the value of the higher bit D4.

The switch 113A is interposed between the node N5 and the node N16 to receive the high gradation signal. The switch 113B is interposed between the node N6 and the node N16 to receive the low gradation signal. The switches 113A and 113B output either the high gradation signal or the low gradation signal to the node N16 as one gradation signal corresponding to the digital signal D0 to D5 on the basis of value of the MSB D5.

The precharging circuit 115′ according to the fourth embodiment precharges the node N16 to a predetermined voltage when the higher bit group D4 and D5 of the digital signal are changed. As shown in FIG. 16, the precharging circuit 115′ has a switch 158 and a switch 159. The switch 158 temporarily precharges the node N16 to the first voltage VDD when the higher bit group D4 and D5 are changed. The switch 159 temporarily precharges the node N16 to the fourth voltage VEE when the higher bit group D4 and D5 are changed.

When the MSB D5 is changed from “0” to “1”, more specifically, when the higher bit group D5 and D4 are changed from “00” or “01” to “10” or “11”, the following operation will be carried out. Firstly, the switches 113B, 113A-1 to 113B-2 and 159 are temporarily turned off, and the switch 113A and 158 are temporarily turned on. Thus, the node N16 and N5 are precharged to the first voltage VDD. Thereafter, the switch 158 is turned off to stop the precharging operation. The switch 113A-1 or the switch 113A-2 is turned on next in response to the higher bit D4 to select a desired gradation signal.

When the higher bit D5 is changed form “1” to “0”, more specifically, when the higher bit group D5 and D4 are changed from “10” or “11” to “00” or “01”, the following operation will be carried out. Firstly, the switches 113A, 113A-1 to 113B-2 and 158 are temporarily turned off, and the switch 113B and 159 are temporarily turned on. Thus the node N16 and N6 are precharged to the fourth voltage VEE. Thereafter, the switch 159 is turned off to stop the precharging operation. The switch 113B-1 or the switch 113B-2 is turned on next in response to the higher bit D4 to select a desired gradation signal.

When the MSB D5 remains as “0” and the higher bit D4 is changed, more specifically, when the higher bit group D5 and D4 are changed from “00” to “01” or from “01” to “00”, the following operation will be carried out. Firstly, the switches 113A, 113A-1 to 113B-2 and 158 are temporarily turned off, and the switch 113B and 159 are temporarily turned on. Thus, the node N16 and N6 are precharged to the fourth voltage VEE. Thereafter, the switch 159 is turned off to stop the precharge operation. The switch 113B-1 or the switch 113B-2 is turned on next in response to the higher bit D4 to select a desired gradation signal.

When the MSB D5 remains as “1” and the higher bit D4 is changed, more specifically, when the higher bit group D5 and D4 are changed from “10” to “11” or from “11” to “10”, the following operation will be carried out. Firstly, the switches 113B, 113A-1 to 113B-2 and 159 are temporarily turned off, and the switch 113A and 158 are temporarily turned on. The node N16 and N5 are thus precharged to the first voltage VDD. Thereafter, the switch 158 is turned off to stop the precharge operation. The switch 113A-1 or the switch 113A-2 is turned on next in response to the higher bit D4 to select a desired gradation signal.

These precharging operations prevent the D/A converters 11A to 12B from being applied with a voltage higher than the breakdown voltages. These precharging operations are carried out only when the value of the higher bit group is changed, which will result in a reduction of the useless charging/discharging power in the precharge.

The level shift circuit group 2 is configured in the same manner with the above embodiments.

According to the fourth embodiment, the selecting circuit 13′, the precharging circuit 115′ and the buffer 117 are formed from high voltage components. Meanwhile, the D/A converters 11A to 12B are formed from low voltage components. Accordingly, the circuit area in the D/A converting circuit 1′ and the data line driver circuit is further reduced. It is also possible to reduce the power consumption in the D/A converting circuit 1′ owing to the low operation voltages in the D/A converters 11A to 12B.

As described above, according to the present invention, it is possible to reduce the circuit area of the D/A converting circuit. The reduction of consumed power in the D/A converting circuit is also possible. Moreover, the reduction of consumed power in a display apparatus using the D/A converting circuit is also possible. The D/A converting circuit according to the present invention is applicable not only for the display apparatus but also for a sound source of cellular phones or printer heads. A substrate in which the D/A converting circuits are integrated may be a semiconductor substrate other than silicone, a glass substrate and a plastic substrate. A transistor is not limited to the MOS transistor, and may be a bipolar transistor and an organic transistor or the like.

### Fifth Embodiment

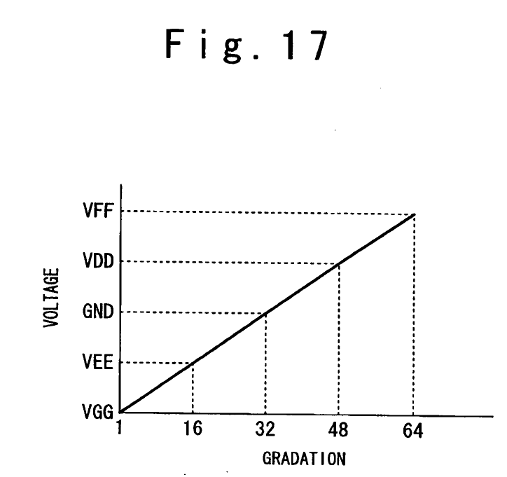

FIG. 18 is a block diagram of the configuration of the liquid crystal display apparatus 60 according to the present invention. Similar to FIG. 7, this liquid crystal display apparatus 60 includes the display panel 63 on which an image is displayed. The display panel 63 includes a plurality of pixels 66 arranged in a matrix. The display panel 63 also includes a plurality of scan lines X1 to Xm and a plurality of data lines Y1 to Yn that are formed to intersect one another. The pixels 66 are arranged at a plurality of intersection points, respectively. Each pixel 66 includes a TFT, a liquid crystal, and a common electrode. The TFT has a gate electrode connected to a corresponding scan line, and a source terminal or a drain terminal connected to a corresponding data line. The liquid crystal has one end connected to the source terminal or the drain terminal of the TFT, and the other end connected to the common electrode thereof to which a constant common voltage is applied. The scan lines X1 to Xm are connected to a scan line driver circuit 62. A control circuit 67 outputs scan line driving signals to the scan line driver circuit 62. The scan line driver circuit 62 sequentially drives the scan lines X1 to Xm according to the scan line driving signals. The data lines Y1 to Yn are connected to a data line driver circuit 61. The control circuit 67 outputs data line driving signals to the data line driver circuit 61 to drive the data line driver circuit 61 and pixels on which digital data is displayed. The data line driver circuit 61 drives the data lines Y1 to Yn according to the data line driving signals. Specifically, the data line driver circuit 61 outputs pixel voltages to the data lines Y1 to Yn in accordance to the respective pixel data. By doing so, the pixel voltages according to the respective pixel data are applied to the pixels 66 connected to one selected scan line X. By sequentially driving the scan lines X1 to Xm, an image is displayed on the display panel 2.

According to the present invention, the liquid crystal display apparatus 1 is driven by a “dot inversion driving method”. Namely, polarities of the pixel voltages applied to the adjacent pixels 66 are opposite to each other. Here, the “polarity” indicates whether a pixel voltage is positive or negative relative to a common voltage applied to the common electrode. In FIG. 18, for example, the polarity of the pixel voltage applied to a pixel 66a is opposite to that of the pixel voltage applied to an adjacent pixel 66b or 66c. Therefore, the data line driver circuit 61 generates pixel voltages having positive and negative polarities, and applies the pixel voltages having different polarities to the adjacent data lines Y1 and Y2, respectively. In addition, the data line driver circuit 61 inverts polarities of the pixel voltages applied to the respective data lines Y for every horizontal period. The data line driver circuit 61 also inverts polarities of the pixel voltages applied to the respective data lines Y for every frame. By using such a dot inversion driving method, flickers or the like are reduced and image quality is improved.

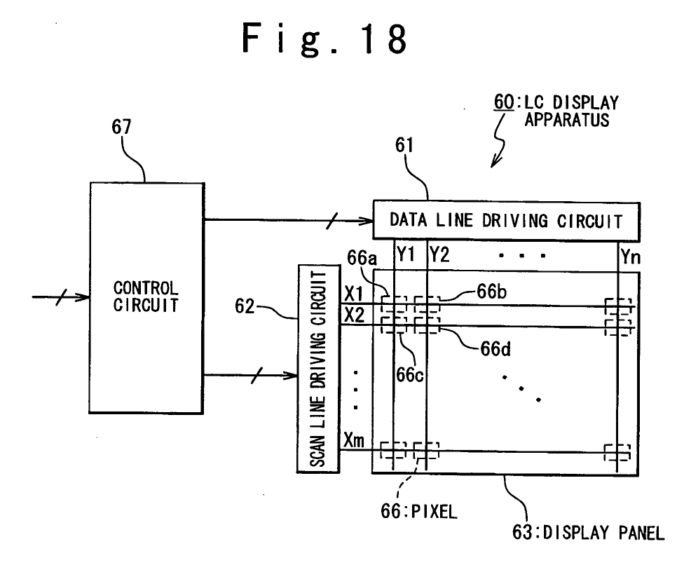

FIG. 19 is a block diagram showing the configuration of the data line driver circuit 61 according to the present invention. The data line driver circuit 61 includes the D/A converting circuit 1, the gradation voltage generating circuit 4, the level shift circuit group 2, and the logic circuit 3. The respective circuits will be outlined below.

The D/A converting circuit 1 converts the digital signal indicating pixel data into an analog voltage signal (a gradation signal). An output of the D/A converting circuit 1 is connected to the data lines Y1 to Yn. In the fifth embodiment, the D/A converting circuit 1 uses the digital signal of six bits “D5, D4, D3, D2, D1 and D0”. The most significant bit (MSB) of this digital signal is D5 and a least significant bit (LSB) thereof is D0. The lower bit group is bits D0 to D4 other than the MSB. This 6-bit digital signal D0 to D5 can express 64 gradation levels. For instance, the digital signal “000000” expresses a 0-th gradation level, the digital signal “011111” expresses a 31^{th} gradation level, the digital signal “100000” expresses a 32^{th} gradation level, and the digital signal “111111” expresses a 63^{th} gradation level. According to the dot inversion driving method, one gradation level corresponds to one positive polarity pixel voltage and one negative polarity pixel voltage. Accordingly, the pixel voltage will be referred to as a “gradation voltage”, the positive polarity gradation voltage will be referred to as a “positive polarity gradation voltage”, and the negative polarity gradation voltage will be referred to as a “negative polarity gradation voltage”. The 64 gradation levels correspond to 64 positive polarity gradation voltages V0P to V63P and 64 negative polarity gradation voltages V0N to V63N, respectively.

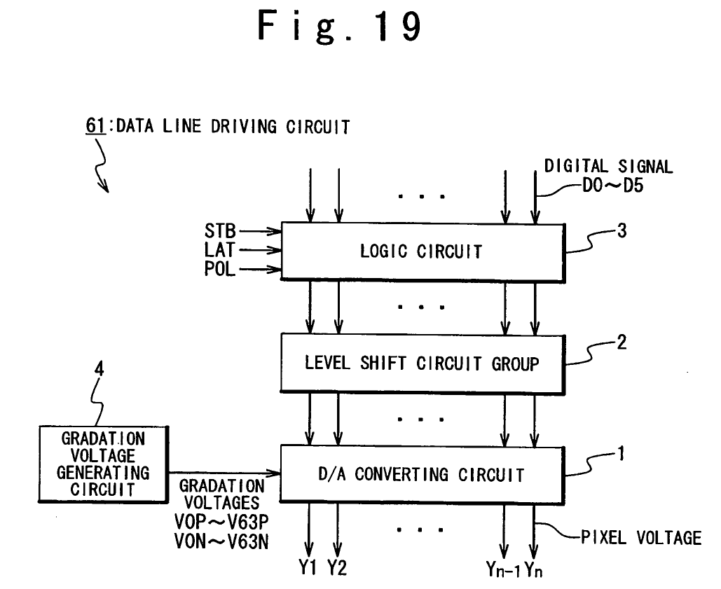

FIG. 20 shows one example of a correspondence between a gradation and a gradation voltage. On a positive polarity side, the positive polarity gradation voltages V0P to V63P correspond to 0^{th} to 63^{th} gradation levels, respectively. On a negative polarity side, the negative polarity gradation voltages V0N to V63N correspond to 0^{th} to 63^{th} gradation levels, respectively. Hereinafter, it is assumed that a gradation voltage is higher if it is closer to the positive polarity gradation voltage V0P and is closer to a ground (system ground) voltage GND if it is closer to the positive polarity gradation voltages V63P. It is also assumed that a gradation voltage is lower if it is closer to the negative polarity gradation voltage V0N and is closer to a ground (system ground) voltage GND if it is closer to the negative polarity gradation voltages V63N. If a voltage is applied to a pixel when the TFT is turned off, an offset voltage is generated due to a field through of the TFT. Therefore, a voltage of about −2 to zero volts and a voltage of about zero to two volts are supplied, as a common voltage, for an n-type TFT and a p-type TFT, respectively.

As shown in FIG. 20, a voltage range including the positive polarity gradation voltages V31P to V0P will be referred to as a “first voltage range (VDD1 to VDD2)”. The first voltage range is specified as a range between the first voltage VDD1 and a second voltage VDD2 (e.g., 5 V) lower than the first voltage VDD1. A voltage range including the positive polarity gradation voltages V63P to V32P will be referred to as a “second voltage range (GND to VDD2)”. The second voltage range is specified as a range between a reference voltage (GND) and a second voltage VDD2 (e.g., 2.7 V) higher than the reference voltage. Voltage range including the negative polarity gradation voltages V63N to V32N will be referred to as a “third voltage range (VDD3 to GND)”. The third voltage range is specified as a range between the reference voltage GND and a third voltage VDD3 (e.g., −2.8 V) lower than the reference voltage. A voltage range including the negative polarity gradation voltages V0N to V31N will be referred to as a “fourth voltage range (VDD4 to VDD3)”. The fourth voltage range is specified as a range between the third voltage VDD3 and a fourth voltage VDD4 (e.g., −5 V) lower than the third voltage VDD3. A fifth voltage range is specified as a range between the reference voltage and the first voltage VDD1. A sixth voltage range is specified as a range between the reference voltage and the fourth voltage VDD4. A seventh voltage range including all gradation voltages is specified as a range between a voltage equal to or higher than the first voltage VDD1 and a voltage equal to or lower than the fourth voltage VDD4. The first voltage VDD1 and the fourth voltage VDD4 may be generated by a power supply circuit (not shown) such as a DC-DC converter. The second voltage VDD2 and the third voltage VDD3 are generated by the gradation voltage generating circuit 4 to be described later.

The gradation voltage generating circuit 4 outputs the positive polarity gradation voltages V0P to V63P and the negative polarity gradation voltages V0N to V63N to the D/A converting circuit 1. Specifically, the gradation voltage generating circuit 4 outputs a gradation signal (an analog voltage signal) having each gradation voltage to the D/A converting circuit 1. It should be noted that in the following description, reference symbols V0P to V63P and V0N to V63N represent not only the respective gradation voltages but also gradation signals having the respective gradation voltages. Namely, voltages of positive polarity gradation signals (positive polarity analog voltage signals) V0P to V63P are the gradation voltages V0P to V63P, and voltages of negative polarity gradation signals (negative polarity analog voltage signals) V0N to V63N are the gradation voltages V0N to V63N.

The logic circuit 3 receives the digital signal D0 to D5 indicating pixel data, a horizontal synchronization signal STB, a latch signal LAT, and a polarity signal POL from the control circuit 67. The logic circuit 3 outputs a control signal for controlling display of an image based on the horizontal synchronization signal STB, the latch signal LAT, the polarity signal POL and the like. The digital signal D0 to D5 and the control signal are transmitted to the D/A converting circuit 1 through the level shift circuit group 2. The level shift circuit group 2 includes a plurality of level shift circuits that convert voltage levels of the digital signal and the control signal to be fit with the D/A converting circuit 1.

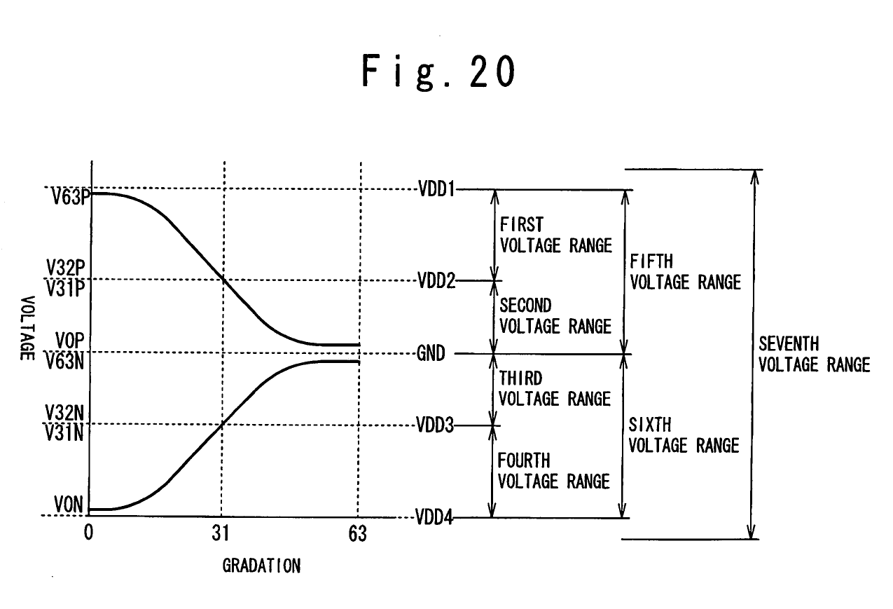

A configuration and operation of the data line driver circuit 61 according to the fifth embodiment of the present invention will be described in more detail. FIG. 21 is a circuit block diagram of the configuration of the D/A converting circuit 1 according to the fifth embodiment of the present invention. The D/A converting circuit 1 drives the two adjacent data lines Y1 and Y2. An output terminal T1 of the D/A converting circuit 1 is connected to the data line Y1, and an output terminal T2 thereof is connected to the data line Y2. One of the positive polarity gradation signals V0P to V63P is applied to one of the data lines Y1 and Y2, whereas one of the negative polarity gradation signals V0N to V63N is applied to the other data line Y2 or Y1. As shown in FIG. 21, the D/A converting circuit 1 in the fifth embodiment includes a first positive polarity D/A converter PH 11-1 and a second positive polarity D/A converter PL 11-2 in a D/A converter 11, a positive polarity selector 13A, and precharge switch section 14A and 15. These circuits handle the positive polarity signals V0P to V63P, and decide one positive polarity gradation signal according to a positive polarity side digital signal (hereinafter, to be referred to a “first digital signal”). The D/A converting circuit 1 also includes a first negative polarity D/A converter NH 12-1 and a second negative polarity D/A converter NL 12-2 in the D/A converter 12, a negative polarity selector 13B, and precharge switch section 14B and 15. These circuits handle the negative polarity signals V0N to V63N, and decide one negative polarity gradation signal according to a negative polarity side digital signal (hereinafter, to be referred to a “second digital signal”). Further, the D/A converting circuit 1 includes a polarity selecting circuit 16. This polarity selecting circuit 16 outputs one positive polarity gradation signal to one of the data lines Y1 and Y2 and one negative polarity gradation signal to the other data line.

The circuit configuration of one D/A converter in this embodiment will be described. For simplicity, a case of the digital signal of two bits (D0 and D1) will be described. The configuration of the D/A converter in this embodiment is the same as shown in FIG. 4A or 4B. However, the reference symbols V0 to V3 are used in place of V1 to V4. The configuration of the D/A converting circuit 1 on the positive polarity side will first be described.

The first positive polarity D/A converter PH 11-1 is configured to operate in the first voltage range VDD1 to VDD2. Accordingly, the positive polarity gradation signals V32P to V63P corresponding to the first voltage range VDD1 to VDD2 are supplied to the first positive polarity D/A converter PH 11-1 (see FIG. 20). The positive polarity gradation signals V32P to V63P are supplied by the positive polarity gradation signal generating circuit 41 included in the gradation voltage generating circuit 4. The first positive polarity D/A converter PH 11-1 outputs one positive polarity gradation signal (hereinafter, to be referred to as a “first positive polarity gradation signal”) according to the lower bit group D0 to D4 of the first digital signal among the positive polarity gradation signals V32P to V63P. Namely, the first positive polarity D/A converter PH 11-1 converts the lower bit group D0 to D4 of the input first digital signal into an analog signal, thereby generating the first positive polarity gradation signal. For instance, if the lower bit group D0 to D4 is “11111”, the gradation signal V31P is selected as the first positive polarity gradation signal. The first positive polarity D/A converter PH 11-1 outputs the second positive polarity gradation signal to the positive polarity selector 13A.

The second positive polarity D/A converter PL 11-2 is configured to operate in the second voltage range GND to VDD2. Accordingly, the positive polarity gradation signals V0P to V31P corresponding to the second voltage range GND to VDD2 are supplied to the second positive polarity D/A converter PL 11-2 (see FIG. 20). The positive polarity gradation signals V0P to V31P are supplied by a positive polarity gradation signal generating circuit 41 included in the gradation voltage generating circuit 4. The second positive polarity D/A converter PL 11-2 outputs one positive polarity gradation signal (hereinafter to be referred to as a “second positive polarity gradation signal”), corresponding to the lower bit group D0 to D4 of the first digital signal, of the positive polarity gradation signals V0P to V31P. Namely, the second positive polarity D/A converter PL converts the lower bit group D0 to D4 of the first digital signal into an analog signal, thereby generating the second positive polarity gradation signal. For instance, if the lower bit group D0 to D4 is “00000”, the gradation signal V0P is selected as the second positive polarity gradation signal. The first positive polarity D/A converter PL 11-2 outputs the second positive polarity gradation signal to the positive polarity selector 13A.

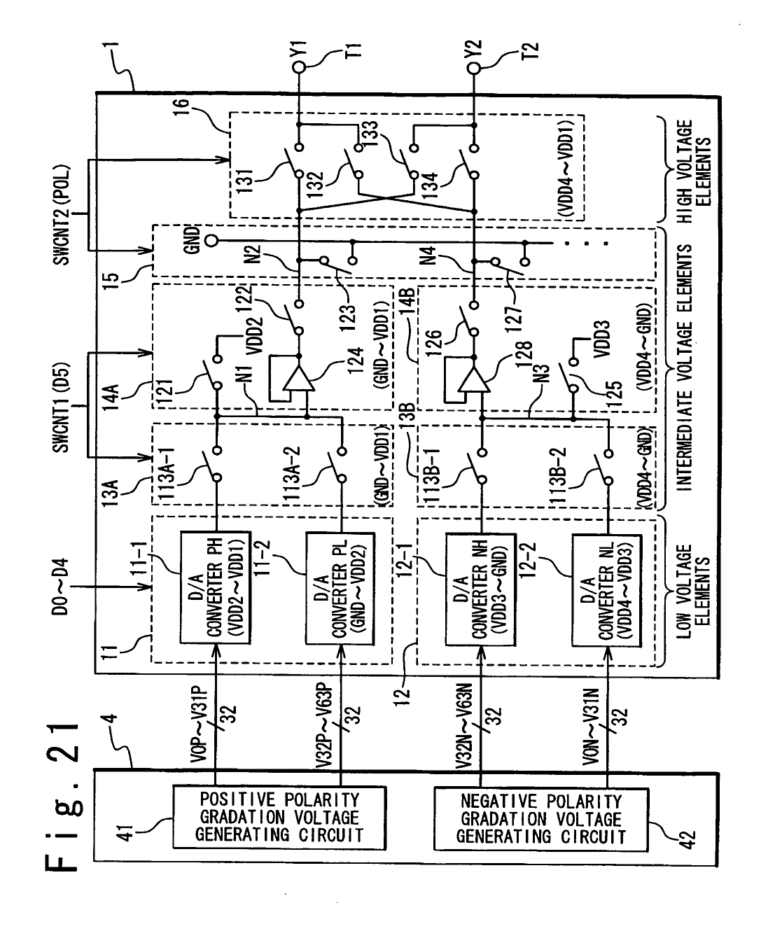

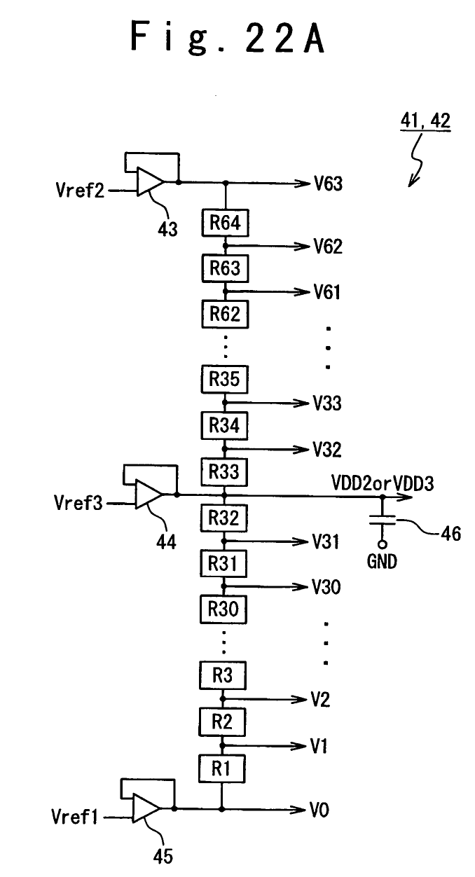

FIGS. 22A and 22B show examples of the circuit configuration of the positive polarity gradation voltage generating circuit 41. The positive polarity gradation voltage generating circuit 41 includes a resistor string circuit excellent in monotonic increment. For instance, FIG. 22A shows a resistor string circuit in which a plurality of resistors R1 to R64 are connected in series. Reference voltages Vref2, Vref3, and Vref4 are supplied to this resistor string circuit through voltage followers 43, 44, and 45, respectively. In addition, a plurality of positive polarity gradation voltages V0 to V63 are generated from respective connection points. The reference voltage Vref3 is supplied to a connection point between the resistors R31 and R32, and a capacity 46 is connected to the connection point and used as a power supply of the first voltage VDD2. In this case, positive polarity gradation voltages V31P and V32P corresponding to intermediate gradations are near the first voltage VDD2. FIG. 22B shows a resistor string circuit in which a plurality of resistors R1 to R63 are connected in series. In this case, the positive polarity gradation voltage V31P corresponding to an intermediate gradation serves as the second voltage VDD2.

The positive polarity selector 13A receives the first positive polarity gradation signal from the first positive polarity D/A converter PH 11-1 and the second positive polarity gradation signal from the second positive polarity D/A converter PL 11-2. Accordingly, the positive polarity selector 13A is configured to operate in the fifth voltage range GND to 1. The positive selector 13A selects one of the first positive polarity gradation signal and the second positive polarity gradation signal according to the MSB D5 of the first digital signal. Specifically, the positive polarity selector 13A includes switches 113A-1 and 113A-2. A control signal SWCNT1 indicating a state of the MSB D5 controls the selector 13A to turn on or off the switches 113A-1 and 113A-2. If the MSB D5 is “1”, the second positive polarity gradation signal V32P to V63P are selected. Therefore, the control signal SWCNT1 controls the positive polarity selector 13A to turn off the switch 113A-1 and turn on the switch 113A-2. In this case, the positive polarity selector 13A selects the second positive polarity gradation signal received from the second positive polarity D/A converter PL 11-2. If the MSB D5 is “0”, the positive polarity gradation signal V0P to V31P are selected. Therefore, the control signal SWCNT1 controls the positive polarity selector 13A to turn on the switch 113A-1 and turn off the switch 113A-2. In this case, the positive polarity selector 13A selects the first positive polarity gradation signal received from the first positive polarity D/A converter PH 11-1. The positive polarity selector 13A outputs the selected one positive polarity gradation signal to a node N1. The node N1 is connected to an input of a voltage follower 124 in the switch section 14A, an amplification factor of which is 1. An output of the voltage follower 124 is connected to a node N2. The node N2 is connected to the polarity selecting circuit 16. The one positive polarity gradation signal stated above is supplied to the polarity selecting circuit 16 through the voltage follower 124. It is noted that the precharge switches 121 to 123 are configured to precharge the nodes N1 and N2 with predetermined voltages. A precharging operation will be described later. The voltage follower 124 and the precharge switches 121 to 123 are configured to operate in the fifth voltage range GND to VDD1 similarly to the positive polarity selector 13A.

The negative polarity side configuration of the D/A converting circuit 1 will next be described. The first negative polarity D/A converter NH 12-1 is configured to operate in the third voltage range VDD3 to GND. Accordingly, the negative polarity gradation signals V32N to V63N corresponding to the third voltage range VDD3 to GND are supplied to the first negative polarity D/A converter NH 12-1 (see FIG. 20). The negative polarity gradation signals V32N to V63N are supplied by a negative polarity gradation signal generating circuit 42 included in the gradation voltage generating circuit 4. The first negative polarity D/A converter NH 12-1 outputs one negative polarity gradation signal (hereinafter, to be referred to as a “first negative polarity gradation signal”) according to the lower bit group D0 to D4 of the second digital signal among the negative polarity gradation signals V32N to V63N. Namely, the first negative polarity D/A converter NH 12-1 converts the lower bit group D0 to D4 of the input second digital signal into an analog signal, thereby generating the first negative polarity gradation signal. For instance, if the lower bit group D0 to D4 is “00000”, the gradation signal V32N is selected as the first negative polarity gradation signal. The first negative polarity D/A converter NH 12-1 outputs the first negative polarity gradation signal to the negative polarity selector 13B.

The second negative polarity D/A converter NL 12-2 is configured to operate in the fourth voltage range VDD4 to VDD3. Accordingly, the negative polarity gradation signals V0N to V31N corresponding to the fourth voltage range VDD4 to VDD3 are supplied to the second negative polarity D/A converter NL 12-2 (see FIG. 20). The negative polarity gradation signals V0N to V31N are supplied by the negative polarity gradation signal generating circuit 42 included in the gradation voltage generating circuit 4. The second negative polarity D/A converter NL 12-2 outputs one negative polarity gradation signal (hereinafter, to be referred to as a “second negative polarity gradation signal”) corresponding to the lower bit group D0 to D4 of the second digital signal, from among the negative polarity gradation signals V0N to V31N. Namely, the second negative polarity D/A converter NL 12-2 converts the lower bit group D0 to D4 of the input second digital signal into an analog signal, thereby generating the second negative polarity gradation signal. For instance, if the lower bit group D0 to D4 is “11111”, the gradation signal V31N is selected as the second negative polarity gradation signal. The second negative polarity D/A converter NL 12-2 outputs the second negative polarity gradation signal to the negative polarity selector 13B.

The first negative polarity D/A converter NH 12-1 and the second negative polarity D/A converter NL 12-2 are same in circuit configuration as that shown in FIG. 4A or 4B. Further, the negative polarity gradation voltage generating circuit 42 is same in circuit configuration to that shown in FIG. 22A or 22B. The capacity 46 is connected to the connection point between the resistors R31 and R32 and used as a power supply of the third voltage VDD3. The negative polarity selector 13B receives the first negative polarity gradation signal from the first negative polarity D/A converter NH 12-1, and the second negative polarity gradation signal from the second negative polarity D/A converter NL 12-2. Accordingly, the negative polarity selector 13B is configured to operate in the sixth voltage range VDD4 to GND. The selector 13B selects one of the first negative polarity gradation signal and the second negative polarity gradation signal according to the MSB D5 of the second digital signal. Specifically, the negative polarity selector 13B includes switches 113B-1 and 113B-2. The control signal SWCNT1 indicating the state of the MSB D5 controls the negative polarity selector 13B to turn on or off the switches 113B-1 and 113B-2. If the MSB D5 is “1”, the negative polarity gradation signals V32N to V63N are selected. Therefore, the control signal SWCNT1 controls the negative polarity selector 13B to turn on the switch 113B-1 and turn off the switch 113B-2. In this case, the negative polarity selector 13B selects the first negative polarity gradation signal received from the first negative polarity D/A converter NH 12-1. If the MSB D5 is “0”, the negative polarity gradation signals V0N to V31N are selected. Therefore, the control signal SWCNT1 controls the negative polarity selector 13B to turn off the switch 113B-1 and turn on the switch 113B-2. In this case, the negative polarity selector 13B selects the second negative polarity gradation signal received from the second negative polarity D/A converter NH 12-2. The negative polarity selector 13B outputs the selected one negative polarity gradation signal to a node N3. The node N3 is connected to an input of the voltage follower 128 of the switch section 14B, an amplification factor of which is 1. An output of the voltage follower 128 is connected to a node N4. The node N4 is connected to the polarity selecting circuit 16. The one negative polarity gradation signal stated above is supplied to the polarity selecting circuit 16 through the voltage follower 128 and the switch 126. It should be noted that the precharge switches 125 to 127 are configured to precharge the nodes N3 and N4 with predetermined voltages. The precharging operation will be described later. The voltage follower 128 and the precharge switches 125 to 127 are configured to operate in the sixth voltage range VDD4 to GND similarly to the negative polarity selector 13B.

The configuration of the polarity selecting circuit 16 will be described. The polarity selecting circuit 16 receives one positive polarity gradation signal from the positive polarity selector 13A and one negative polarity gradation signal from the negative polarity selector 13B. Accordingly, the polarity selecting circuit 16 is configured to operate in the seventh voltage range VDD4 to VDD1. This polarity selecting circuit 16 outputs one positive polarity gradation signal to one of the data lines Y1 and Y2 and one negative polarity gradation signal to the other data line. Specifically, the polarity selecting circuit 16 includes switches 131 to 134. The switch 131 is provided between the node N2 and the output terminal T1, and the switch 133 is provided between the node N2 and the output terminal T2. The switch 132 is provided between the node N4 and the output terminal T1, and the switch 134 is provided between the node N4 and the output terminal T2. A control signal SWCNT2 controls the polarity selecting circuit 16 to turn on or off these switches 131 to 134 to indicate a state of the polarity signal POL. For instance, if the polarity signal POL is “1”, the control signal SWCNT2 controls the polarity selecting circuit 16 to turn on the switches 131 and 134 and to turn off the switches 132 and 133. In this case, the polarity selecting circuit 16 outputs the positive polarity gradation signal to the data line Y1, and the negative polarity gradation signal to the data line Y2. If the polarity signal POL is “0”, the control signal SWCNT2 controls the polarity selecting circuit 16 to turn off the switches 131 and 134 and to turn on the switches 132 and 133. In this case, the polarity selecting circuit 16 outputs the positive polarity gradation signal to the data line Y2, and the negative polarity gradation signal to the data line Y1.

As can be seen, the gradation signals different in polarity are outputted to the adjacent data lines Y1 and Y2, respectively. As a result, the polarities of the voltage signals applied to the adjacent pixels (3a and 3b; and 3c and 3d) are opposite to each other. Thus, the dot inversion driving is realized. Alternatively, the polarity signal POL (control signal SWCNT2) can invert the polarities of the voltage signals to the positive or negative polarity. It is preferable that a value of the polarity signal POL is switched over between “0” and “1” for every horizontal period. If so, the polarities of the gradation voltages applied to the data lines Y1 and Y2 are inverted for every horizontal period. As a result, the polarities of the pixel voltages applied to the adjacent pixels (3a and 3c; 3c and 3d) are opposite to each other. Therefore, the dot inversion driving (line inversion driving) is realized.

As stated above, the positive polarity D/A converters PH and PL 11-1 and 11-2, the negative polarity D/A converters NH and NL 12-1 and 12-2, the positive polarity selector 13A, the negative polarity selector 13B, and the polarity selecting circuit 16 operate in different voltage ranges, respectively. The positive polarity selector 13A operates in the fifth voltage range GND to VDD1 and the negative polarity selector 13B operates in the sixth voltage range VDD4 to GND, and the selectors 13A and 13B are manufactured using “intermediate voltage components”. In addition, the polarity selecting circuit 16 operates in the seventh voltage range VDD4 to VDD1 and is manufactured using “high voltage components”. On the other hand, the positive polarity D/A converters PH and PL 11-1 and 11-2, and the negative polarity D/A converters NL and NH 12-1 and 12-2 operate in a narrower voltage ranges, and can be manufactured using “low voltage components” lower in breakdown voltage than the intermediate voltage components. Namely, according to the present embodiment, the components of the positive polarity D/A converters PH and PL 11-1 and 11-2 and the negative polarity D/A converters NL and NH 12-1 and 12-2 may be lower in breakdown voltage than those according to the conventional technique. As a result, the components of the positive polarity D/A converters PH and PL 11-1 and 11-2 and the negative polarity D/A converters NH and NL 12-1 and 12-2 can be designed to have a small gate length L and a small gate width W. Therefore, it is possible to reduce a circuit area for the positive polarity D/A converters PL and PH and the negative polarity D/A converters NL and NH.

As can be understood, according to the present embodiment, the areas of the circuits for D/A converting circuit can be reduced without using an amplifier, the amplification factor α of which is higher than one. It is sufficient that the positive polarity gradation signal and the negative polarity gradation signal are outputted to the data lines Y through the voltage followers 124 and 128, respectively. Since a deviation in amplification factor α due to the manufacturing deviation of the amplifiers is eliminated, the accuracy of the pixel voltages supplied to the data lines Y can be improved. That is, it is possible to not only reduce the area of the data line driver circuit 61 but also prevent image quality degradations such as “blur”. If the dot inversion driving method is applied, in particular, the configuration according to the present invention is effective. Further, since the operation voltages of the D/A converters PH, PL, NH, and NL are reduced, the consumed power of the data line driver circuit 61 can be reduced.

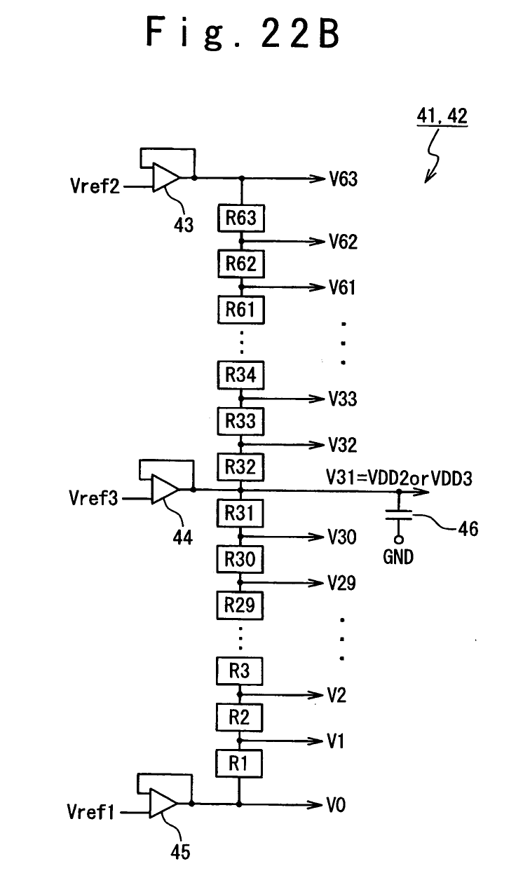

Voltage levels of the signals transmitted from the logic circuit 3 to the respective circuits different in operation voltage may be appropriately changed by the level shift circuit group 2 shown in FIG. 19. For instance, FIG. 23 shows an example of the configuration of the level shift circuit group 2. The level shift circuit group 2 includes level shift circuits 51 to 57. The level shift circuit 51 changes a voltage level of the lower bit group D0 to D4 to fit with the operation voltage range (VDD2 to VDD1) of the first positive polarity D/A converter PH 11-1. The level shift circuit 52 changes the voltage level of the lower bit group D0 to D4 to fit with the operation voltage range (GND to VDD2) of the second positive polarity D/A converter PL 11-2. The level shift circuit 53 changes a voltage level of the lower bit group D0 to D4 to fit with the operation voltage range (VDD3 to GND) of the first negative polarity D/A converter NH 12-1. The level shift circuit 54 changes the voltage level of the lower bit group D0 to D4 to fit with the operation voltage range (VDD4 to VDD3) of the second negative polarity D/A converter NL 12-2.

Furthermore, the logic circuit 3 outputs the control signal SWCNT1 based on the state of the MSB D5 and the control signal SWCNT2 based on the state of the polarity signal POL. The level shift circuit 55 changes voltage levels of the control signals SWCNT1 and SWCNT2 to fit with the operation voltage range (GND to VDD1) of the positive polarity-side switches 113A-1, 113A-2, and 121 to 123. The level shift circuit 56 converts voltage levels of the control signals SWCNT1 and SWCNT2 to fit with the operation voltage range (VDD4 to GND) of the negative polarity-side switches 113B-1, 113B-2, 125 to 127. The level shift circuit 57 converts the voltage level of the control signal SWCNT2 to fit with the operation voltage range (VDD4 to VDD1) of the polarity selecting circuit 16.

The precharging operation for the nodes N2 and N4 will first be described. Referring to FIG. 21, the node N2 or N4 is precharged to the ground voltage GND in response to the control signal SWCNT2. Specifically, during the precharging operation, the precharge switch 122 is turned off and the precharge switch 123 is turned on in response to the control signal SWCNT2. In addition, during the precharging operation, the precharge switch 126 is turned off and the precharge switch 127 is turned on in response to the control signal SWCNT2. The precharge switches 123 and 127 are connected to the ground line. By turning on those switches 123 and 127, the nodes N2 and N4 are precharged to the ground voltage GND, respectively.

The reason that the nodes N2 and N4 are precharged is to prevent voltages other than the operation voltages from being applied to the respective voltage followers 124 and 128. For instance, the voltage follower 124 is connected to the node N2 through the switch 122, and the node N2 is connected to the output terminals T1 and T2 through the respective switches 131 and 133. As described above, the polarities of the gradation voltages applied to the output terminal T1 (data line Y1) and the output terminal T2 (data line Y2) are inverted in accordance with the control signal SWCNT2. Therefore, to prevent the life of each component from being shortened, it is necessary to prevent the negative polarity gradation voltage V0N to V63N from being applied to the voltage follower 124 that operates in the fifth operation voltage range GND to VDD1. For this purpose, the switch 122 is turned off, the precharge switch 123 is turned on, and the node N2 is precharged to the ground voltage GND. In this respect, it is preferable that the precharging operation is executed when the switches 131 to 134 within the polarity selecting circuit 16 are changed over. In other words, it is preferable that the precharging operation is carried out when the polarity signal POL is changed, and is controlled based on the control signal SWCNT2 which is based on the state of the polarity signal POL. The same thing is true for the node N4.

The precharging operation for the nodes N1 and N3 will be described. Referring to FIG. 21, the node N1 is precharged to the second voltage VDD2 in response to the control signal SWCNT1. Specifically, during the precharging operation, the switches 113A-1 and 113A-2 are turned off and the precharge switch section 121 is turned on in response to the control signal SWCNT1. The precharge switch 121 is connected to the node N1 and the power supply of the second voltage VDD2 (FIGS. 22A and 22B). By turning on the precharge switch 121, the node N1 is precharged to the second voltage VDD2. In addition, the node N3 is precharged to the third voltage VDD3 in response to the control signal SWCNT1. Specifically, during the precharging operation, the switches 113B-1 and 113B-2 are turned off and the precharge switch 125 is turned on in response to the control signal SWCNT1. The precharge switch 125 is connected to the node N3 and the power supply of the third voltage VDD3 (FIGS. 22A and 22B). By turning on the precharge switch 125, the node N3 is precharged with the third voltage VDD3.

The reason why the nodes N1 and N3 are precharged is to prevent voltages other than the operation voltages from being applied to the respective D/A converters PH, PL, NH, and NL. For instance, the second positive polarity D/A converter PL 11-2 operates in the second voltage range GND to VDD2 and is connected to the node N1 through the switch 113A. The positive polarity gradation voltages V0P to V31P outputted from the second positive polarity D/A converter PH 11-1 are also applied to the node N1. Therefore, to prevent the life of each component from being shortened, it is necessary to prevent the voltage other than those in the second voltage range GND to VDD2 from being applied to the second positive polarity D/A converter PL 11-2. For this purpose, the switches 113A-1 and 113A-2 are turned off, the precharge switch 125 is turned on, and the node N1 is precharged to the second voltage VDD2 that is the intermediate gradation voltage. In this respect, it is preferable that the precharging operation is carried out when the switches 113A-1 and 113A-2 within the positive polarity selector 13A are switched over. In other words, it is preferable that the precharge operation is carried out before the MSB D5 of the first digital signal is changed, and is controlled based on the control signal SWCNT1 which is determined based on the state of the MSB D5. The same thing is true for the node N3. The precharge operation for the node N3 is carried out before the MSB D5 of the second digital signal is changed.

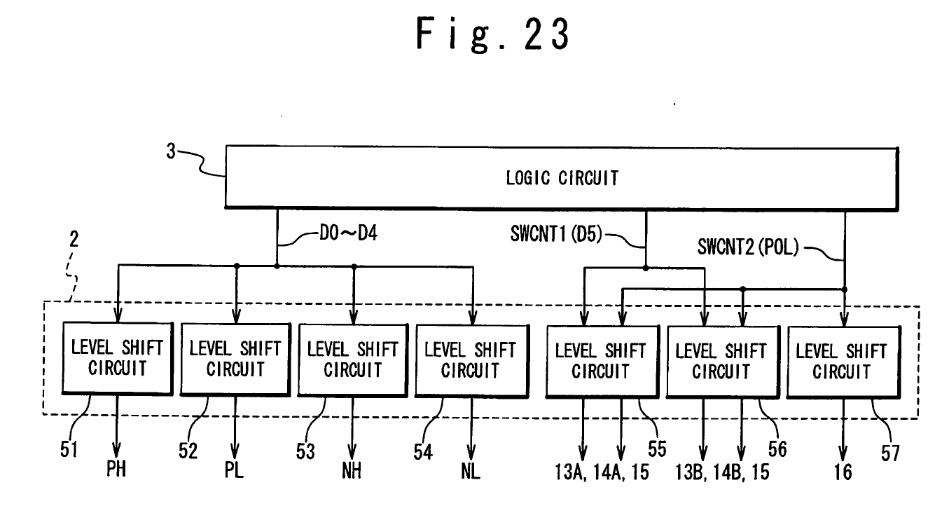

FIG. 24 shows the configuration for detecting a change of the MSB D5 of the digital signal and for precharging the node N1. In FIG. 24, only positive polarity-side circuits are shown. Since negative polarity-side circuits and their operations are the same as those of the positive polarity-side circuits and their operations, they will not be often described herein. In addition, FIG. 24 shows that latch circuits and precharge circuits are provided separately for a plurality of data lines Y1 to Y(n−1) each having the positive polarity, respectively.

As shown in FIG. 24, the logic circuit 3 includes a first latch circuit 3-1 (3-1-1, 3-1-(n−1)), a second latch circuit 3-2 (3-2-1, 3-2-(n−1)), and a change detection circuit 3-3 (3-3-1, 3-3-(n−1)). The first latch circuit 3-1 and the second latch circuit 3-2 are circuits that latch the six bits D0 to D5 of the digital signal. The first latch circuit 3-1 latches the six bits D0 to D5 of the digital signal in response to a sampling signal SMP outputted from a shift register (not shown) and synchronized with a clock signal. On the other hand, the second latch circuit 3-2 simultaneously latches the bits D0 to D5 of the digital signal latched by the first latch circuit 3-1 in response to a latch signal LAT. The latch circuit 3-2 also holds the six bits D0 to D5 of the digital signal for a predetermined period such as one horizontal period. The digital signal held in the second latch circuit 3-2 is a current digital signal. The digital signal held in the first latch circuit 3-1 is a digital signal for a next step. Therefore, by comparing the digital signal held in the first latch circuit 3-1 with that held in the second latch circuit 3-2, it is possible to detect a change of the MSB D5. The change detection circuit 3-3 is provided to detect this change.

The change detection circuit 3-3 is controlled by a control signal C1. If the control signal C1 is “1”, the change detection circuit 3-3 compares the MSB bit D5 held in the first latch circuit 61 with that held in the second latch circuit 62. If the two MSBs D5 do not coincide with each other, i.e., if the MSB D5 has been changed, the change detection circuit 3-3 outputs the precharge control signal SWCNT1. The precharge control signal SWCNT1 is a switch control signal for turning off the switches 113A-1 and 113A-2 and turning on the precharge switch 121 (121-1, 121-(n−1)). The precharge control signal SWCNT1 is supplied to the switches 113A-1 and 113A-2 and the precharge switch 121 through the level shift circuit 2 (2-1, 2-(n−1)). The node N1 is thereby precharged to the second voltage VDD2. This precharging operation can suppress the service life of each component from being shortened.

If the two MSBs D5 coincide, i.e., the MSB D5 has been not changed, the change detection circuit 3-3 does not output the precharge control signal SWCNT1. In this case, states of the switches 113A-1 and 113A-2, and the precharge switch 121 are not changed. That is, if the MSB D5 is not changed, there is no probability that voltages equal to or higher than the breakdown voltage are applied to the positive polarity D/A converters PH and PL 11-1 and 11-2. Therefore, the precharging operation is not carried out. It is thereby possible to reduce unnecessary charge and discharge power by the precharge operation.

If the control signal C1 is “0”, the change detecting circuit 3-3 outputs the ordinary control signal SWCNT1. If the MSB D5 is “1”, the change detecting circuit 3-3 outputs a control signal SWCNT for turning off the switch 113A-1, turning on the switch 113A, and turning off the switch 121. In this case, the positive polarity gradation voltage (V32P to V63P) selected by the second positive polarity D/A converter PL 11-2 is outputted to the node N1. If the MSB D5 is “0”, the change detecting circuit 3-3 outputs the control signal SWCNT for turning on the switch 113A-1 and turning off the switches 113A-2 and 121. In this case, the positive polarity gradation voltage (V0P to V31P) selected by the first positive polarity D/A converter PH 11-1 is output to the node N1.

As described above, if the latch signal LAT is supplied to the second latch circuit 3-2, a content of the second latch circuit 3-2 is updated to the digital signal for the next step. Therefore, it is preferable that the precharging operation is carried out just before the second latch circuit 3-2 is updated. That is to say, it is preferable that the control signal C1 for controlling the change detecting circuit 3-3 is set to “1” before the latch signal LAT is supplied to the second latch circuit 3-2. For instance, the control signal C1 is set to “1” after a certain horizontal period starts and before the latch signal LAT is supplied. The control signal C1 is set to “0” simultaneously with the latch signal LAT to the second latch circuit 3-2.

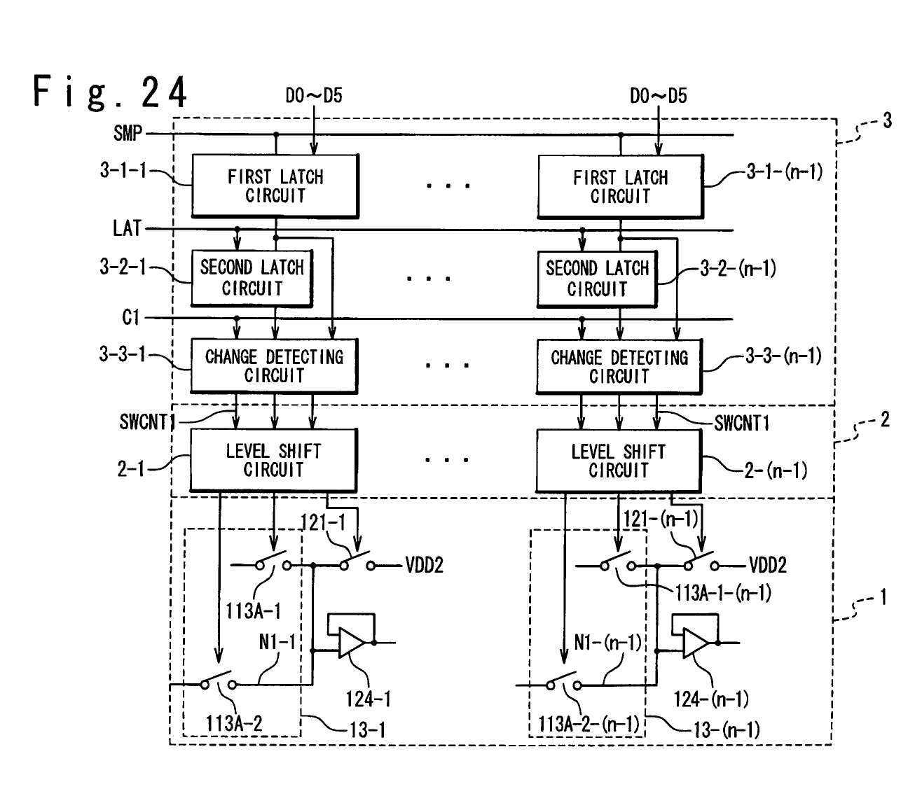

An example of the operation of the data line driver circuit 61 according to the present embodiment will be described with reference to the timing charts shown in FIGS. 25A to 25T. FIGS. 25A to 25T show the horizontal synchronization signal STB, the latch signal LAT, the polarity signal POL, contents of the second latch circuits 3-2, states of the respective switches, the voltages at the respective nodes, and the gradation voltages applied to the data lines Y1 and Y2, respectively.

Here, it is assumed that the latch circuit 3-2-1 stores the positive polarity digital signal (first digital signal). Contents of the six bits D0 to D5 of this positive polarity digital signal are transmitted to the positive polarity D/A converters PH and PL 11-1 and 11-2 or used to control the positive polarity-side switches 113A-1, 113A-2 and 121. It is also assumed herein that the latch circuit 3-2-2 stores the negative polarity digital signal (second digital signal). Contents of the six bits D0 to D5 of this negative polarity digital signal are transmitted to the negative polarity D/A converters NH and NL 121-1 and 12-2 or used to control the negative polarity-side switches 113B-1, 113B-2 and 125. The polarities of the gradation voltages supplied to the data lines Y1 and Y2 are inverted for every horizontal period. Accordingly, the digital signal corresponding to the data line Y1 may be alternately supplied to the latch circuits 62-1 and 62-2.

In a first horizontal period, the polarity signal POL is “1”. In this period, the positive polarity gradation voltage is applied to the data line Y1, and the negative polarity gradation voltage is applied to the data line Y2. Therefore, the first digital signal “111111” corresponding to the data line Y1 is stored in the latch circuit 3-2-1, and the second digital signal “000000” corresponding to the data line Y2 is stored in the latch circuit 3-2-2. The second positive polarity D/A converter PL 11-2 selects the positive polarity gradation voltage V63P and the first positive polarity D/A converter PH 11-1 selects the positive polarity gradation voltage V31P according to the lower bit group “11111” of the first digital signal. In addition, the switch 113A-1 is turned off and the switch 121-1 is turned on according to the MSB “1” thereof. The positive polarity gradation voltage V63P is thereby applied to the nodes N1 and N2.

Further, the first negative polarity D/A converter NH 12-1 selects the negative polarity gradation voltage V32N and the second negative polarity D/A converter NL 12-2 selects the negative polarity gradation voltage V0N according to the lower bit group “00000” of the second digital signal. In addition, the switch 113B-1 is turned off and the switch 113B-2 is turned on in response to the MSB “ ” thereof. The negative polarity gradation voltage V0N is thereby applied to the nodes N3 and N4. If the polarity signal POL is “1”, the switches 131 and 134 are turned on and the switches 132 and 133 are turned off in the polarity selecting circuit 16. As a result, the positive polarity gradation voltage V63P according to the first digital signal “111111” is applied to the data line Y1. The negative polarity gradation voltage V0N according to the second digital signal “000000” is applied to the data line Y2.

At a time t20, the horizontal synchronization signal STB rises and a second horizontal period starts. In addition, at the time t20, the polarity signal POL is inverted synchronously with the horizontal synchronization signal STB. If the polarity signal POL is “0”, then the negative polarity gradation voltage is applied to the data line Y1, and the positive polarity gradation voltage is applied to the data line Y2. Therefore, in response to the later latch signal LAT, the second digital signal “111111” for the data line Y1 is latched by the latch circuit 3-2-2. In addition, in response to the later latch signal LAT, the first digital signal “000000” for the data line Y2 is latched by the latch circuit 3-2-1.

The above-stated precharging operation is carried out before the latch signal LAT is supplied to the second latch circuits 3-2-1 and 3-2-2. Therefore, at the time t20, the control signal C1 is set to “1” synchronously with the horizontal synchronization signal STB. At this time, the digital signal “111111” for the data line Y1 in the first horizontal period is stored in the second latch circuit 3-2-1. The digital signal “000000” for the data line Y2 in the second horizontal period is stored in the first latch circuit 3-1-1. Accordingly, the change detecting circuit 3-3-1 detects that the two MSBs do not coincide with each other and outputs the precharge control signal SWCNT1. The switches 113A-1 and 113A-2 are thereby turned off and the switch 121-1 is turned on. As a result, the node N1 is precharged to the second voltage VDD2. Further, the digital signal “000000” for the data line Y2 in the first horizontal period is stored in the second latch circuit 3-2-2. The digital signal “111111” for the data line Y1 in the second horizontal period is stored in the first latch circuit 3-1-2. Accordingly, the change detecting circuit 3-3-2 detects that the two MSBs do not coincide with each other and outputs the precharge control signal SWCNT1. The switches 113B-1 and 113B-2 are thereby turned off and the switch 125 is turned on. As a result, the node N3 is precharged to the third voltage VDD3. Furthermore, the nodes N2 and N4 are precharged for a few clocks' time since the horizontal synchronization signal STB is set to “1”, i.e., for a few clocks' time since the polarity signal POL is inverted. Specifically, the switches 122 and 126 are turned off and the switches 1123 and 127 are turned on. The nodes N2 and N4 are thereby precharged with the ground voltage GND. Further, since the switches 31 and 34 are turned on, the data lines Y1 and Y2 are also precharged to the ground voltage GND.

At a time t21, the horizontal synchronization signal STB is changed to “0”, and the latch signal LAT is supplied to the second latch circuits 3-2-1 and 3-2-2. The digital signals latched by the first latch circuits 3-1 are simultaneously transferred to and latched by the second latch circuits 3-2. As a result, the first digital signal “000000” for the data line Y2 is stored in the second latch circuit 3-2-1. The second digital signal “111111” for the data line Y1 is stored in the second latch circuit 3-2-2. At the time t21, the control signal C1 is returned to “0”. The switches 121 and 125 are thereby turned off and the precharging of the nodes N1 and N3 is finished.

The second positive polarity D/A converter PL 11-2 selects the positive polarity gradation voltage V32P and the second positive polarity D/A converter PH 11-1 selects the positive polarity gradation voltage V0P based on the lower bit group “00000” of the first digital signal. In addition, the switch 113A-1 is turned on and the switch 121 is turned off in response to the MSB “0” thereof. The positive polarity gradation signal V0P is thereby applied to the node N1. The first negative polarity D/A converter NH 12-1 selects the negative polarity gradation voltage V63N and the second negative polarity D/A converter NL 12-2 selects the negative polarity gradation voltage V31N in response to the lower bit group “11111” of the second digital signal. In addition, the switch 113B-1 is turned on and the switch 113B-2 is turned off in response to the MSB “1” thereof. The negative polarity gradation voltage V63N is thereby applied to the node N3.

After passage of a few clocks, at a time t22, the switches 122 and 126 are turned on and the switches 123 and 127 are turned off in response to the control signal SWCNT2. The precharging of the nodes N2 and N4 is thereby finished. At the time t22, the switches 131 and 134 are turned off and the switches 132 and 133 are turned on in the polarity selecting circuit 16 in response to the control signal SWCNT2. As a result, the positive polarity gradation voltage V0P corresponding to the first digital signal “000000” is applied to the data line Y2. In addition, the negative polarity gradation voltage V63N corresponding to the second digital signal “111111” is applied to the data line Y1.

At a time t30, the horizontal synchronization signal STB rises, and a third horizontal period starts. At the time t30, the polarity signal POL is inverted synchronously with the horizontal synchronization signal STB. If the polarity signal POL is “1”, the positive polarity gradation voltage is applied to the data line Y1, and the negative polarity gradation voltage is applied to the data line Y2. Before the latch signal LAT is supplied to the second latch circuits 3-2-1 and 3-2-2, the above-stated precharging operation is carried out. Therefore, at the time t30, the control signal C1 is set to “1” synchronously with the horizontal synchronization signal STB. At this time, the digital signal “000000” for the data line Y2 in the second horizontal period is stored in the second latch circuit 3-2-1. The digital signal “000000” for the data line Y1 in the third horizontal period is stored in the first latch circuit 3-1-1. Since the two MSBs D5 coincide with each other, the change detecting circuit 3-3-1 does not output the precharge control signal SWCNT1. Accordingly, a state in which the switch 113A-1 is turned on, and in which the switch 121 is turned off is maintained. It is thereby possible to reduce unnecessary charge and discharge power by the precharge operation.

Further, the digital signal “111111” for the data line Y1 in the second horizontal period is stored in the second latch circuit 3-2-2. In addition, the digital signal “000000” for the data line Y2 in the third horizontal period is stored in the first latch circuit 3-1-2. Accordingly, the change detecting circuit 3-3-2 detects that the two MSBs D5 do not coincide with each other, and outputs the precharge control signal SWCNT1. The switches 113B-1 and 113B-2 are thereby turned off and the switch 24 is turned on. As a result, the node N3 is precharged to the third voltage VDD3. Furthermore, the nodes N2 and N4 are precharged for a few clocks' time since the horizontal synchronization signal STB is set to “1”, i.e., for a few clocks' time since the polarity signal POL is inverted. Specifically, the switches 122 and 126 are turned off and the switches 123 and 127 are turned on. The nodes N2 and N4 are thereby precharged with the ground voltage GND. Further, since the switches 132 and 133 are turned on, the data lines Y1 and Y2 are also precharged to the ground voltage GND.

At a time t31, the horizontal synchronization signal STB is changed to “0”, and the latch signal LAT is supplied to the second latch circuits 3-2-1 and 3-2-2. The digital signals latched by the first latch circuits 3-1 are simultaneously transferred to and latched by the second latch circuits 3-2. As a result, the first digital signal “000000” for the data line Y1 is stored in the second latch circuit 3-2-1. The second digital signal “000000” for the data line Y2 is stored in the second latch circuit 3-2-2. At the time t31, the control signal C1 is returned to “0”. The switch 125 is thereby turned off and the precharging of the node N3 is finished.

The second positive polarity D/A converter PL 11-2 selects the positive polarity gradation voltage V32P and the first positive polarity D/A converter PH 11-1 selects the positive polarity gradation voltage V0P in response to the lower bit group “00000” of the first digital signal. In addition, the switch 113A-1 is turned on and the switch 121 is turned off in response to the MSB “0” thereof. The positive polarity gradation signal V0P is thereby applied to the node N1. The first negative polarity D/A converter NH 12-1 selects the negative polarity gradation voltage V32N and the second negative polarity D/A converter NL 12-2 selects the negative polarity gradation voltage V0N in response to the lower bit group “000000” of the second digital signal. In addition, the switch 113B-1 is turned off and the switch 113B-2 is turned on in response to the MSB “0” thereof. The negative polarity gradation voltage V0N is thereby applied to the node N3.

After passage of a few clocks, at a time t32, the switches 122 and 126 are turned on and the switches 123 and 127 are turned off in response to the control signal SWCNT2. The precharging on the nodes N2 and N4 is thereby finished. At the time t32, the switches 131 and 134 are turned on and the switches 132 and 133 are turned off in the polarity selecting circuit 16 in response to the control signal SWCNT2. As a result, the positive polarity gradation voltage V0P corresponding to the first digital signal “000000” is applied to the data line Y1. In addition, the negative polarity gradation voltage V0N corresponding to the second digital signal “000000” is applied to the data line Y2.

In the present embodiment, the polarity selecting circuit 16 is configured to operate in the seventh voltage range VDD4 to VDD1, and is manufactured using “high voltage component”. The positive polarity selector 13A is configured to operate in the fifth voltage range GND to VDD1, and the negative polarity selector 13B is configured to operate in the sixth voltage range VDD4 to GND. Accordingly, each of the positive polarity selector 13A and the negative polarity selector 13B can be manufactured using “intermediate voltage components” lower in breakdown voltage than the high voltage components. In addition, each of the positive polarity D/A converters PH and PL 11-1 and 11-2, the negative polarity D/A converters NH and NL 12-1 and 12-2 can be manufactured using “low voltage components” lower in breakdown voltage than the intermediate voltage components. Breakdown voltages of the high voltage component, the intermediate voltage component, and the low voltage component are, for example, twelve volts, six volts, and three volts, respectively. Features that appear due to such a difference in operation voltage and a difference in breakdown voltage will be described.

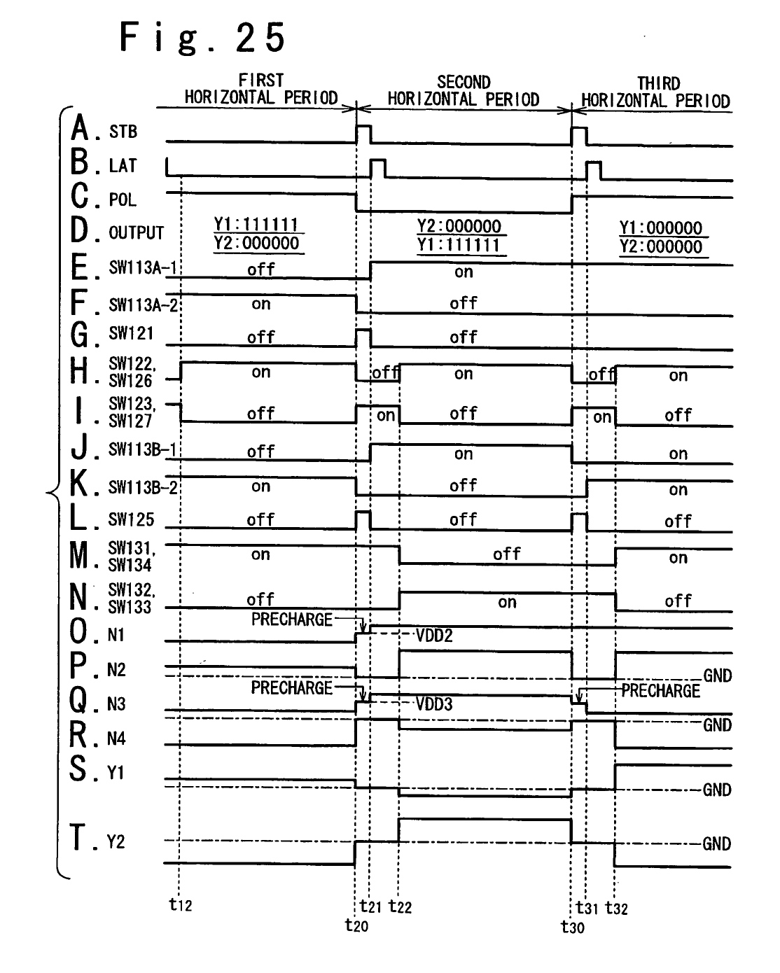

FIG. 26 is a schematic plan view of a layout of the data line driver circuit 61. Various operation voltages are used for the respective circuits, and the circuits different in operating circuit are arranged in different regions on a substrate. For instance, the second positive polarity D/A converter PL 11-2 operates in the second voltage range GND to VDD2 and is formed in a first region 71 on a substrate 70. The first positive polarity D/A converter PH 11-1 operates in the first voltage range VDD2 to VDD1 and is formed in a second region 72 on the substrate 70. The first negative polarity D/A converter NH 12-1 operates in the second voltage range VDD3 to GND and is formed in a third region 73 on the substrate 70. The second positive polarity D/A converter NL 12-2 operates in the fourth voltage range VDD4 to VDD3 is formed in a fourth region 74 on the substrate 70.

The respective regions are separated from one another by a deep N-well layer. Further, the liquid crystal display apparatus includes a plurality of D/A converting circuit 1 in correspondence to a plurality of data lines Y1 to Yn, respectively. Accordingly, the plurality of second positive polarity D/A converters PL 11-2 are provided. For instance, the second positive polarity D/A converters PL 11-1 may be continuously arranged in the first region 71. Likewise, the positive polarity selector 13A operates in the fifth voltage range GND to VDD1 and is formed in a fifth region 75 on the substrate 70. The negative polarity selector 13B operates in the sixth voltage range VDD4 to GND and is formed on the sixth region 76 on the substrate 70. The polarity selecting circuit 16 operates in the seventh voltage range VDD4 to VDD1 and is formed on a seventh region 77 on the substrate 70.

The respective circuits in the logic circuit 3 (see FIG. 19) are each formed of low voltage components and formed on an eighth region 78 on the substrate 70. The level shift circuit may be provided between the second latch circuit 3-2 and each D/A converting circuit 1 and in front of the first latch circuit 3-1. If the level shift circuit is provided in front of the first latch circuit 3-1, then the logic circuit 3 is formed in a region 78a, and the level shift circuit is formed in a ninth region 79.

Each of the voltage followers 124 and 128 is formed out of intermediate voltage components. In the voltage followers 124 and 128, a deviation in offset voltage may be generated due to the manufacturing deviation. Therefore, it is preferable to manufacture the voltage followers 124 and 128 on a silicon substrate higher in relative component accuracy than a glass substrate. The polarity selecting circuit 16 constituted by the switches 131 to 134 may be formed not on the silicon substrate but on the glass substrate on which pixels are formed.

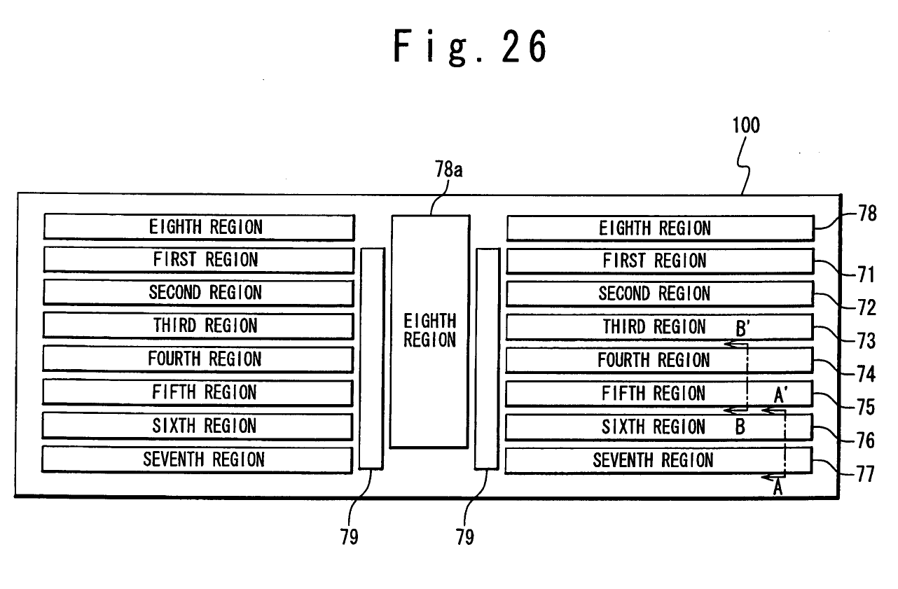

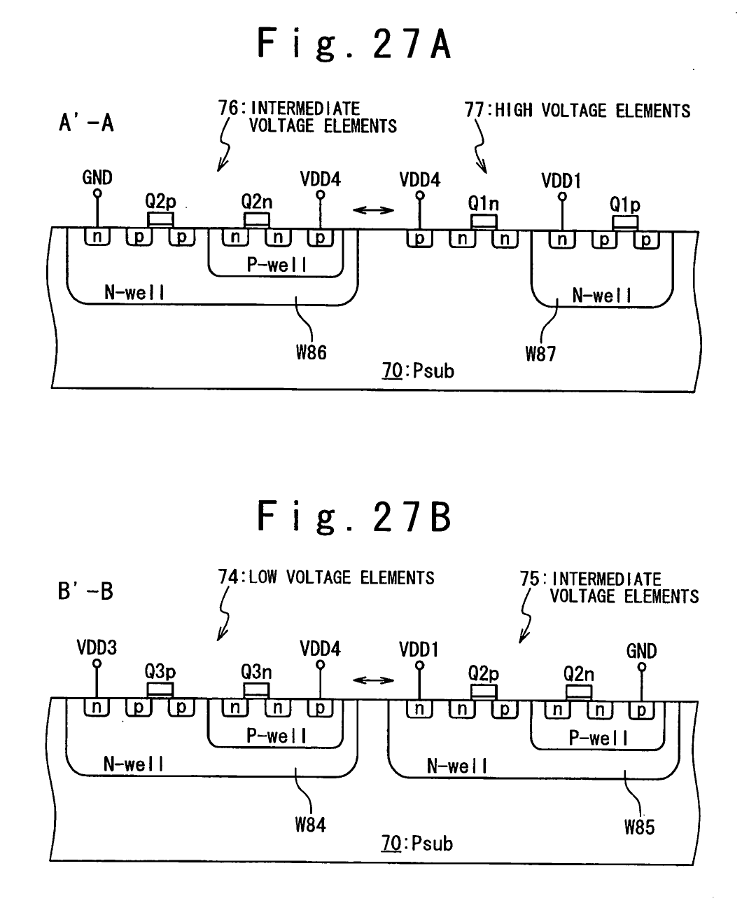

FIG. 27A typically shows a cross-sectional structure taken along a line A-A′ of FIG. 26. FIG. 27B typically shows a cross-sectional structure taken along a line B-B′ of FIG. 26. A fourth N-well W84, a fifth N-well W85, a sixth N-well W86, and a seventh N-well W87 are formed in the P type substrate 70. These fourth to seventh N-wells W84 to W87 correspond to the fourth to seventh regions W74 to W77, respectively. A P-well is formed in the fourth N-well W84. The third voltage VDD3 is applied to the fourth N-well W84, and the fourth voltage VDD4 is applied to the P-well. In addition, a P-channel MOS transistor Q3p is formed on the fourth N-well W84, and an N-channel MOS transistor Q3n is formed on the P-well. A gate electrode of each MOS transistor is formed on the substrate 70 through a gate insulating film F94. These MOS transistors Q3p and Q3n constitute the second negative polarity D/A converter NL that operates in the fourth voltage range VDD4 to VDD3. Namely, the MOS transistors Q3p and Q3n are low voltage components. The respective circuits formed in the first to third and the eighth regions are each manufactured by the MOS transistors Q3p and Q3n. A P-well is formed in the fifth N-well W85. The first voltage VDD1 is applied to the fifth N-well W85, and the ground voltage GND is applied to the P-well. In addition, a P channel MOS transistor Q2p is formed on the fifth N-well W85, and an N channel MOS transistor Q2n is formed on the P-well. A gate electrode of each MOS transistor is formed on the substrate 70 through a gate insulating film 95. These MOS transistors Q2p and Q2n constitute the positive polarity selector 13A that operates in the fifth voltage range GND to VDD1. Namely, the MOS transistors Q2p and Q2n are intermediate voltage components. A P-well is formed in the sixth N-well W86. The ground voltage GND is applied to the sixth N-well 86, and the fourth voltage VDD4 is applied to the P-well. In addition, a P channel MOS transistor Q2p is formed on the sixth N-well 86, and an N channel MOS transistor Q2n is formed on the P-well. A gate electrode of each MOS transistor is formed on the substrate 70 through a gate insulating film F96. These MOS transistors Q2p and Q2n constitute the negative polarity selector 13B that operates in the sixth voltage range VDD4 to GND. Namely, the MOS transistors Q2p and Q2n are intermediate voltage components. The first voltage VDD1 is applied to the seventh N-well W87, and the fourth voltage VDD4 is applied to the P type substrate 70. In addition, a P channel MOS transistor Q1p is formed on the seventh N-well 87, and an N channel MOS transistor Q1n is formed on the P type substrate 70. A gate electrode of each MOS transistor is formed on the substrate 70 through a gate insulating film F97. These MOS transistors Q1p and Q1n constitute the polarity selecting circuit that operates in the seventh voltage range VDD4 to VDD1. Namely, the MOS transistors Q1p and Q1n are high voltage components.

As can be seen, the respective circuits in the first to fourth and the eighth regions are each manufactured from the MOS transistors Q3p and Q3n, which are the low voltage components. The respective circuits in the fifth and sixth regions are each manufactured from the MOS transistors Q2p and Q2n, which are the intermediate voltage components. The respective circuits in the seventh region are each manufactured from the MOS transistors Q1p and Q1n, which are the high voltage components. The MOS transistors Q3p and Q3n may be lower in breakdown voltage than the MOS transistors Q2p and Q2n. The MOS transistors Q2p and Q2n may be lower in breakdown voltage than the MOS transistors Q3p and Q3n. Accordingly, the gate oxide film F94 is smaller in thickness Tox than the gate oxide film F95 and F96. The gate oxide films F95 and F96 are smaller in thickness Tox than the gate oxide film F97. In addition, the MOS transistors Q3p and Q3n are smaller in minimum gate length L and minimum gate width W than the MOS transistors Q2p and Q2n. The MOS transistors Q2p and Q2n are smaller in minimum gate length-L and minimum gate width W than the MOS transistors Q1p and Q1n. Thus, if the breakdown voltage is lower, a circuit area is smaller. If the breakdown voltage is larger, the circuit area is larger.

If the number of bits of the digital signal increases, an area of the D/A converting circuit 1 is made large. Therefore, it is preferable to provide the D/A converting circuit 1 in which the number of high voltage components is minimized as less as possible. According to the present invention, each of the positive polarity converters PH and PL 11-1 and 11-2, and the negative polarity converters NH and NL 12-1 and 12-2 is formed of the low voltage components, and each of the positive polarity selector 13A and the negative polarity selector 13B is formed of the intermediate voltage components. Therefore, a circuit area of the D/A converting circuit 1 is reduced, and that of the data line driver circuit 61 is reduced, accordingly. Since the operation voltages of the respective circuits are suppressed, it is possible to reduce the power consumption of the data line driver circuit 61.

As described above, according to the fifth embodiment, the area of the data line driver circuit 61 can be reduced. For the purpose of reduction of the area, it is not necessary to use the method disclosed in the above second conventional example. Namely, the areas of the circuits for the D/A conversion can be reduced without using an amplifier, the amplification factor α of which is higher than 1. It is sufficient that the positive polarity gradation signal and the negative polarity gradation signal are output to the data lines Y through the voltage followers 124 and 128, respectively. Since a deviation in the amplification factor α due to the manufacturing deviation of the amplifiers is eliminated, the accuracy of the pixel voltages supplied to the data lines Y can be improved. That is, according to the present embodiment, it is possible to not only reduce the area of the data line driver circuit 61 but also prevent image quality degradations such as “blur”. If the dot inversion driving method is applied, in particular, the configuration according to the present invention is effective. Further, since the operation voltages of the D/A converters PH, PL, NH, and NL are reduced, the consumed power of the data line driver circuit 61 can be reduced.

### Sixth Embodiment

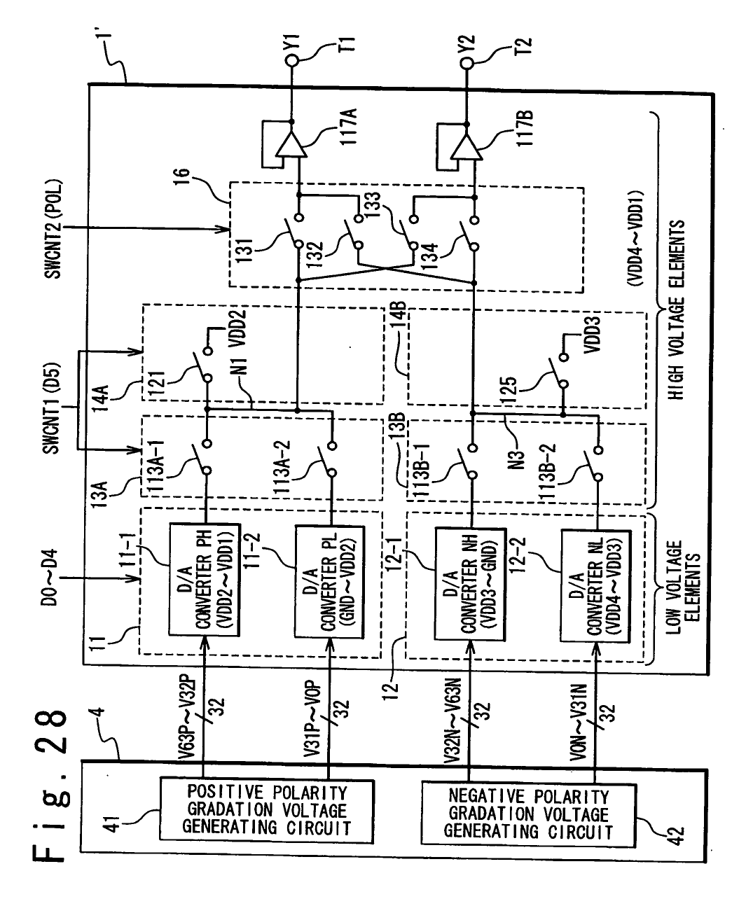

FIG. 28 is a block diagram of the configuration of a D/A converting circuit 1′ according to the sixth embodiment of the present invention. In FIG. 28, the same components as those in the fifth embodiment are allocated with the same reference symbols, respectively, and will not be often described herein.

As shown in FIG. 28, the nodes N1 and N3 are connected in series to the input of the polarity selecting circuit 16. The output of the polarity selecting circuit 16 is connected to the output terminal T1 through the voltage follower 117A, and to the output terminal T2 through the voltage follower 117B. The polarity selecting circuit 16 includes switches 131 to 134. The switch 131 is provided between the node N1 and the voltage follower 1117A. The switch 132 is provided between the node N3 and the voltage follower 117A. The switch 133 is provided between the node N1 and the voltage follower 117B. The switch 134 is provided between the node N3 and the voltage follower 117B. In the sixth embodiment, each of D/A converters PH, PL, NH, and NL 11-1 to 12-2 is formed of low voltage components and each of the other circuits is formed of high voltage components that operate in the seventh voltage range VDD4 to VDD1. For instance, according to the fifth embodiment, each of the positive polarity selector 13A and the negative polarity selector 13B is formed of the intermediate voltage components. According to the sixth embodiment, each of the positive polarity selector 13A and the negative polarity selector 13B is formed of the high voltage components. Accordingly, the positive polarity selector 13A and the negative polarity selector 13B are formed in the seventh region 77 on the substrate 70.

The sixth embodiment can exhibit the same advantages as those of the fifth embodiment. The sixth embodiment exhibits the following additional advantage. The level shift circuit group 2 is simpler in configuration than that shown in FIG. 23. This is because the level shift circuits 55 and 56 can be not required. Since the number of types of level shift circuits is decreased, convenience during design can be improved. Alternatively, each of the positive polarity converters PH and PL 11-1 and 11-2 may be manufactured of the intermediate voltage components and configured to operate in the fifth voltage range GND to VDD1. In addition, each of the negative polarity converters NH and NL 12-1 and 12-2 may be manufactured of the intermediate voltage components and configured to operate in the sixth voltage range VDD4 to GND. If so, since only the level shift circuits 55 to 57 are used, the convenience during design can be further improved.

The substrate in the fifth and sixth embodiments may be any one of a semiconductor substrate, a glass substrate, a plastic substrate, and the like other than the silicon substrate. The transistors are not limited to the MOS transistors but may be bipolar transistors, organic transistors, or the like. Further, the instance in which the reference voltage is the system ground voltage GND has been described. Alternatively, the reference voltage may be a voltage different from the system ground voltage GND.

In the above embodiment, V0P to V31P are supplied to the second D/A converter PL and V32P to V63P are supplied to the first D/A converter PH. However, V0P to V31P are supplied to the first D/A converter PH and V32P to V63P are supplied to the second D/A converter PL.

According to the present invention, it is possible to reduce the circuit area of the D/A converting circuit. It is also possible to reduce consumed power of the D/A converting circuit. It is further possible to reduce consumed power of display apparatus using the D/A converting circuit.

What is claimed is:

1. A driver circuit comprising:
an analog voltage signal generating circuit configured to generate first and second groups of analog voltage signals;
a first D/A converter configured to operate in a first voltage range between a first voltage and a second voltage which is lower than said first voltage, and to output a first one of said first group of analog voltage signals based on a lower bit group of an input digital signal;
a second D/A converter configured to operate in a second voltage range between said second voltage and a third voltage which is lower than said second voltage, and to output a second one of said second group of analog voltage signals based on said lower bit group out; and
a selecting circuit configured to select one of said first analog voltage signal and said second analog voltage signal as an analog voltage selection signal based on an upper bit group of said digital signal.

2. The driver circuit according to claim 1, wherein said second voltage is a system ground voltage.

3. The driver circuit according to claim 1, wherein said selecting circuit operates in a third voltage range between a voltage higher than said first voltage and a voltage lower than said third voltage.

4. The driver circuit according to claim 1, further comprising:
a buffer provided between said selecting circuit and an output terminal and configured to operate in a third voltage range between said first voltage and said fourth voltage.

5. The driver circuit according to claim 1, further comprising:
a precharging circuit configured to precharge a wiring line between said selecting circuit and an output terminal to a predetermined voltage.

6. The driver circuit according to claim 5, wherein said wiring line is precharged when a value of said upper bit group is changed.

7. The driver circuit according to claim 6, wherein when the value of said upper bit group is changed, said precharge is carried out after said selecting circuit disconnects said precharging circuit from said first and second D/A converters.

8. The driver circuit according to claim 5, wherein said predetermined voltage is said second voltage.

9. The driver circuit according to claim 1, wherein each of said first D/A converter, said second D/A converter, and said selecting circuit has a MOS transistor, and
gate insulating films of said MOS transistors in said first and second D/A converters are thinner than a gate insulating film of said MOS transistor in said selecting circuit.

10. The driver circuit according to claim 1, wherein each of said first D/A converter, said second D/A converter, and said selecting circuit has a MOS transistor, and
gate lengths of said MOS transistors in said first and second D/A converters are shorter than a gate length of said MOS transistor in said selecting circuit.

11. A driver circuit comprising:
an analog voltage signal generating circuit configured to generate first to fourth groups of analog voltage signals;
a first D/A converter configured to operate in a first voltage range between a first voltage and a second voltage which is lower than said first voltage, and to output a first one of said first group of analog voltage signals based on a lower bit group of an input digital signal;
a second D/A converter configured to operate in a second voltage range between said second voltage and a third voltage which is lower than said second voltage, and to output a second one of said second group of analog voltage signals based on said lower bit group out;
a third D/A converter configured to operate in a third voltage range between a third voltage and a fourth voltage which is lower than said third voltage, and to output a third one of said first group of analog voltage signals based on a lower bit group of an input digital signal;
a fourth D/A converter configured to operate in a fourth voltage range between said fourth voltage and a fifth voltage which is lower than said fourth voltage, and to output a fourth one of said fourth group of analog voltage signals based on said lower bit group out;
a first selecting circuit configured to select one of said first analog voltage signal and said second analog voltage signal as a first analog voltage selection signal based on an upper bit group of said digital signal; and
a second selecting circuit configured to select one of said third analog voltage signal and said fourth analog voltage signal as a second analog voltage selection signal based on said upper bit group of said digital signal.

12. The driver circuit according to claim 11, wherein said third voltage is a system ground voltage.

13. The driver circuit according to claim 11, wherein said first selecting circuit operates in a fifth voltage range between a sixth voltage higher than said first voltage and said third voltage, and
said second selecting circuit operates in a sixth voltage range between said third voltage and a seventh voltage lower than said fifth voltage.

14. The driver circuit according to claim 11, further comprising:
a third selecting circuit configured to select one of said first analog voltage selection signal and said second analog voltage selection signal as an analog voltage selection signal based on said upper bit group of said digital signal; and
a buffer provided between said third selecting circuit and an output terminal and configured to operate in a seven voltage range between said sixth voltage and said seventh voltage.

15. The driver circuit according to claim 11, further comprising:
an output switching circuit configured to output one of said first analog voltage selection signal and said second analog voltage selection signal as an analog voltage selection signal to one of adjacent output terminals and the other of the selection signals to the other of the adjacent output terminals based on a polarity signal.

16. The driver circuit according to claim 15, further comprising:
a precharging circuit provided between said first and second selecting circuits and said output switching circuit and configured to precharge first wiring lines between said first and second selecting circuits and said output switching circuit to first and second predetermined voltages, and second wiring lines between said first wiring lines and said output terminals to a third predetermined voltage.

17. The driver circuit according to claim 16, wherein said first wiring lines are precharged when a value of said upper bit group is changed, and said second wiring lines are precharged in response to a polarity signal.

18. The driver circuit according to claim 17, wherein when the value of said upper bit group is changed, said precharge is carried out after said first and second selecting circuits disconnect said precharging circuit from said first to fourth D/A converters.

19. The driver circuit according to claim 16, wherein said first predetermined voltage is said second voltage, said second predetermined voltage is said fourth voltage, and said third predetermined voltage is a ground voltage.

20. The driver circuit according to claim 16, wherein each of said first to fourth D/A converter, said first and second selecting circuit, said precharging circuit, and said output switching circuit has a MOS transistor,
gate insulating films of said MOS transistors in said first to fourth D/A converters are thinner than gate insulating films of said MOS transistors in said first and second selecting circuits, and
the gate insulating films of said MOS transistors in said first and second selecting circuits are thinner than a gate insulating film of said MOS transistor in said output switching circuit.

21. The driver circuit according to claim 16, wherein each of said first to fourth D/A converter, said first and second selecting circuit, said precharging circuit, and said output switching circuit has a MOS transistor,
gate lengths of said MOS transistors in said first to fourth D/A converters are shorter than gate lengths of said MOS transistors in said first and second selecting circuits, and
the gate lengths of said MOS transistors in said first to fourth D/A converters are shorter than a gate length of said MOS transistor in said output switching circuit.

22. A display apparatus comprising:
a display panel having data lines; and
a driver circuit configured to drive said display panel based on a digital signal by driving said data lines,
wherein said driver circuit comprises:
a logic circuit configured to latch said digital signal having a lower bit group and a higher bit group;
an analog voltage signal generating circuit configured to generate first and second groups of analog voltage signals; and
a digital-to-analog (D/A) converting circuit configured to drive said data lines based on said digital signal by using said first and second groups of analog voltage signals,
said D/A converting circuit comprises:
a first D/A converter configured to operate in a first voltage range between a first voltage and a second voltage which is lower than said first voltage, and to output a first one of said first group of analog voltage signals based on said lower bit group of an input digital signal;
a second D/A converter configured to operate in a second voltage range between said second voltage and a third voltage which is lower than said second voltage, and to output a second one of said second group of analog voltage signals based on said lower bit group out; and
a first selecting circuit configured to operate in a third voltage range between a voltage higher than said first voltage and a voltage lower than said third voltage, and to select one of said first analog voltage signal and said second analog voltage signal as a first analog voltage selection signal based on said upper bit group of said digital signal.

23. The display apparatus according to claim 22, wherein said /A converting circuit further comprises:
a buffer configured to drive one of said data lines based on said first analog voltage selection signal.

24. The display apparatus according to claim 22, wherein said analog voltage signal generating circuit further generates third and fourth groups of analog voltage signals in addition to said first and second groups of analog voltage signals, and
said D/A converting circuit further comprises:
a third D/A converter configured to operate in a third voltage range between a third voltage and a fourth voltage which is lower than said third voltage, and to output a third one of said first group of analog voltage signals based on a lower bit group of an input digital signal;
a fourth D/A converter configured to operate in a fourth voltage range between said fourth voltage and a fifth voltage which is lower than said fourth voltage, and to output a fourth one of said fourth group of analog voltage signals based on said lower bit group out;
a second selecting circuit configured to select one of said third analog voltage signal and said fourth analog voltage signal as a second analog voltage selection signal based on said upper bit group of said digital signal; and
an output switching circuit configured to output one of said first analog voltage selection signal and said second analog voltage selection signal as an analog voltage selection signal to one of adjacent output terminals and the other of the selection signals to the other of the adjacent output terminals based on a polarity signal.

25. The display apparatus according to claim 22, further comprising:
a level shift circuit group provided between said logic circuit and said D/A converting circuit, and comprising first to third level shift circuits,
wherein said first level shift circuit receives said lower bit group from said logic circuit, and outputs said lower bit group to said first D/A converter after converting said lower bit group to fit with said first voltage range,
said second level shift circuit receives said lower bit group from said logic circuit, and outputs said lower bit group to said second D/A converter after changing said lower bit group to fit with said second voltage range, and
said third level shift circuit receives said upper bit group from said logic circuit, and outputs said upper bit group to said first selecting circuit after changing said upper bit group to fit with said third voltage range.

26. The display apparatus according to claim 24, further comprising:
a level shift circuit group provided between said logic circuit and said D/A converting circuit, and comprising first to seventh level shift circuits,
wherein said first level shift circuit receives said lower bit group from said logic circuit, and outputs said lower bit group to said first D/A converter after converting said lower bit group to fit with said first voltage range,
said second level shift circuit receives said lower bit group from said logic circuit, and outputs said lower bit group to said second D/A converter after changing said lower bit group to fit with said second voltage range,
said third level shift circuit receives said lower bit group from said logic circuit, and outputs said lower bit group to said third D/A converter after converting said lower bit group to fit with said third voltage range,
said fourth level shift circuit receives said lower bit group from said logic circuit, and outputs said lower bit group to said fourth D/A converter after changing said lower bit group to fit with said fourth voltage range,
said fifth level shift circuit receives said upper bit group from said logic circuit, and outputs said upper bit group to said first selecting circuit after changing said upper bit group to fit with said fifth voltage range,
said sixth level shift circuit receives said upper bit group from said logic circuit, and outputs said upper bit group to said second selecting circuit after changing said upper bit group to fit with said sixth voltage range, and
said seventh level shift circuit receives a polarity signal from said logic circuit, and outputs said polarity signal to said output switching circuit after changing said polarity signal to fit with said seventh voltage range.
